(19) United States
(12) Patent Application Publication
(10) Pub. No.: US 2011/0222107 A1
(43) Pub. Date: Sep. 15, 2011

(54) METHODS AND STRUCTURE FOR IMPROVED JDF TICKET PROCESSING IN A PRINTING SYSTEM USING AUTOMATICALLY GENERATED TRANSLATION TABLES

(76) Inventor: David A. Williams, Los Gatos, CA (US)

(21) Appl. No.: 12/721,360

(22) Filed: Mar. 10, 2010

(51) Int. Cl. G06K 15/00

(52) U.S. Cl. 358/1.15

(57) ABSTRACT

Methods and apparatus for generating and utilizing a device capability file and a device PostScript table for processing JDF job tickets within a printing system. Features and aspects hereof generate a device capability file and a device PostScript table from information in a printer description file and a mapping file. The device capability file is used to generate JDF job tickets. The device PostScript table is used in the printing system to translate a JDF job ticket into corresponding device command strings. Constraint information may be generated from the printer description and mapping files and used to validate the JDF job ticket. The constraint information may be integral with the device capability file and/or with the device PostScript table. JDF job tickets may be validated as they are generated, and/or just prior to transmission to the printing system, and/or as part of the job ticket processing within the printing system.

### BACKGROUND

1. Field of the Invention

The invention relates generally to processing of Job Definition Format (JDF) job tickets in a printing environment through generation and use of a device PostScript table, generated from a mapping file and from a printer description file, to simplify processing in the printing system for processing of JDF job tickets.

2. Discussion of Related Art

In many printing environments, including print shops (large and small) as well as production printing and even smaller workgroup environments, it is generally known to create JDF information describing the processing required to print a particular print job. JDF is an international standard that defines a set of keywords and file structures to be used for common tasks of the printing process; in particular, the construction of job tickets and device capability files. JDF is typically used in the field of production printing, where the print jobs are more complex and demanding than in office or home printing. Job tickets contain all the parameters necessary for the processing of a print job. Device capability files describe the features available on a particular device and also serve as templates from which job tickets guaranteed to be executable can be generated for the device (e.g., generated by a printer driver of a computer system or other suitable content generating programs). The JDF job ticket and device capability file formats are described in the document “JDF Specification, Release 1.4” by the CIP4 organization (Cooperation for the Integration of Processes in Prepress, Press, and Postpress). This standard is well known to those of ordinary skill in the art and information regarding the standards is available at www.cip4.com.

By contrast to the JDF standards, digital printer manufacturers commonly use sets of keywords to describe the features and optional settings of their devices. These keywords are often different from the names and values used to define features in the JDF standard. Further, the selected keywords describing features and settings of printing systems often vary between different manufacturers and sometimes even vary between printing systems models produced by the same manufacturer. In the case of PostScript printers, the information specific to a particular printer is published by the manufacturer as a PostScript Printer Description (PPD) file. PPD files have a standard syntax and grammar described in the document “PostScript Printer Description File Format Specification” by Adobe Systems, Inc. The PPD syntax and grammar are well known to those of ordinary skill in the art and background information regarding PPD syntax and grammar is available at www.adobe.com

The feature names in such a manufacturer supplied PPD file may not match directly the feature names in accordance with the JDF standards. Thus, a translation process is required between the JDF features and the printer capability features. Current solutions bridge the divide between JDF and manufacturer feature and setting values by processing the job ticket and content file in a host-based controller external to the printing system. This processing determines which device control functions are required by a provided JDF job ticket and then combines the corresponding command sequences for those device control functions with the content file to produce a temporary print file. This temporary print file is then sent to the printing system to produce the output as specified by the original job ticket and content file. The process of determining the appropriate command sequences and combining them properly with the content to be printed may be implemented by a host-based application that either reads the PPD file on the fly or has the PPD data hard-coded within it. Such an application also has the liberty of rewriting the content file as necessary to insert command sequences at the appropriate points within the content.

Some printing systems may include processing capabilities to directly receive a JDF job ticket and corresponding content files and may process the job ticket within the processing capabilities of the printing system, per se. In such a case, there is no intermediate controller and no temporary print file is created. The parsing of the job ticket and determination of the appropriate device command sequences must be performed by the printing system (i.e., by a printer controller of the printing system).

Problems may arise in such printing systems that directly process the JDF job tickets.

The job ticket must be created by a client (e.g., driver and/or application program) that restricts the ticket to the JDF equivalents of the features available on the printing system. Further, the client should take care to honor any constraints on combinations of features in a job ticket to be processed by the printing system. Certain combinations of features and/or settings may be impossible for a particular printing system to process. The host-based client application that creates the job ticket and the printer-based JDF interpreter that processes the ticket may not use the same mapping of JDF elements and attributes to device features in order for the application user to reliably get the expected printed output. Further, the client and the printing system may not agree on features that are not implemented by device commands. For example, page content scaling and transformation may be implemented by PostScript procedures in some printing systems but not in other printing systems.

JDF job tickets may specify different attributes for different sections of a document. When such section specific JDF attributes (features) are translated into device commands and PostScript procedures, there may be more than one set of device commands that need to be executed on the printing system during the printing of the document. Still further, proper accounting of input page descriptions and output printed sheets is necessary to determine when specific sets of commands corresponding to specific sections of a document should be executed.

When multiple commands are required at the same point in a print job, the order in which they should be executed on the printing system may be critical. Such ordering information is typically determined from information in the PPD file not generally accessible to the controller of the printing system.

A job ticket may require a device to be in a particular configuration or to have an optional accessory installed. The device configuration is typically checked in present solutions by using query code applied to the printing system and provided in the PPD file—again, not generally available to the printing system.

A job ticket may have attributes that are not in conflict according to the JDF standard, but when translated into device commands, result in a combination of commands that is prohibited by the printing system. Such prohibitions are typically defined by a constraint statement in the PPD file—once again, not generally available to the printing system.

Although processing JDF job tickets within a printing system presents the above and other challenges, it remains desirable to do so for a variety of reasons. For performance reasons, it is often desirable for the printing system to accept PostScript content in its original form. This relieves the host-based client application of the need to write a temporary print file that can be quite large for some content files. Thus, by processing the job within the printing system, the client application can return control quickly to the user or immediately begin to monitor printer status. For other performance reasons, when the printing system receives the content file, it is preferable to process the content directly from the input channel as opposed to writing it out to a temporary file on a disk drive coupled with the printing system. This form of processing may be achieved only if there is no need to reorder the pages contained in the content file based on the printing system having knowledge of the complete job to be performed based on the job ticket features.

It is thus an ongoing challenge to provide a printing system that realizes the above optimizations while maintaining flexibility and fidelity of job ticket processing during printing of a print job. More generally, it is an ongoing challenge to robustly and efficiently process JDF job tickets and associated print job data within the printing system.

### SUMMARY

The present invention solves the above and other problems, thereby advancing the state of the useful arts, by providing methods and associated structure for generating and utilizing a device capability file and a device PostScript table to improve processing of JDF job tickets within a printing system. Features and aspects hereof generate a device capability file and a device PostScript table from information in a PPD file for a device and from a mapping file. The device capability file may be used to generate JDF job tickets. The device PostScript table is used in the printing system as a lookup table to translate elements in the JDF job ticket into corresponding device command strings. Optional features and aspects hereof also generate constraint information from the printer description file and from the mapping file. The constraint information may be used in the computing system that generates job tickets and/or in the printing system to validate the JDF job ticket. In one exemplary embodiment, the device PostScript table and the constraint information are generated as PostScript dictionaries in a PostScript printing system and the processing of the JDF job ticket may be implemented as a PostScript program.

One aspect hereof provides for a method for printing a print job on a printing system. The method comprises providing a printer description file for the printing system. The printer description file including a plurality of entries each entry associating a device feature name and a device feature setting name and a corresponding device command string. The method further comprises providing a mapping file having a plurality of entries wherein each entry maps one or more Job Definition Format (JDF) feature names to one or more device feature names and to one or more device feature setting names and generating, in a computing system, a device capability file based on the printer description file and on the mapping file. The device capability file associating each of a plurality of Job Definition Format (JDF) feature names with a corresponding one or more device feature setting names. The method also comprises generating a device PostScript table based on the printer description file and the mapping file. The device PostScript table associating one or more JDF feature names with one or more device feature setting names and with one or more device command strings corresponding to the one or more device feature setting names. The method further comprises generating, in the computing system, a JDF job ticket for a print job based on the device capability file and transmitting the JDF job ticket and print job data associated with the print job from the computing system to the printing system. The method also comprises translating, within the printing system, entries of the JDF job ticket into corresponding device command strings based on entries in the device PostScript table and executing, within the printing system, the corresponding device command strings and the print job data to generate printed output for the print job.

Another aspect hereof provides a method operable in a PostScript printing system controller for processing a Job Definition Format (JDF) job ticket associated with a print job. The method comprising providing a device PostScript table stored within the PostScript printing system controller. The device PostScript table having a plurality of entries, each entry mapping one or more JDF feature names and JDF setting names to a device command string to be executed by the printing system controller to invoke a desired JDF feature. The method further comprises receiving a JDF job ticket and associated print job data wherein the JDF job ticket comprises one or more JDF elements each specifying a desired JDF feature name and a desired JDF feature setting name and locating an entry in the device PostScript table based on one or more desired JDF feature names and one or more desired JDF feature setting names. The method further comprises processing a value field of the located entry to generate one or more device command strings and processing the one or more generated device command strings and the print job data to generate printed output.

Yet another aspect hereof provides a system comprising a computing system. The computing system further comprising a mapping file having a plurality of entries wherein each entry maps one or more Job Definition Format (JDF) feature names to one or more device feature names and to one or more device feature setting names. The computing system further comprises a printer description file comprising information regarding available device feature names and device feature setting names of a corresponding printing system and a printing system initialization component coupled to receive the printer description file. The printing system initialization component is adapted to generate a device capability files based on the printer description file and based on the mapping file. The device capability file comprising entries associating one or more available device feature setting names with one or more corresponding JDF feature names. The printing system initialization component is further adapted to generate a device PostScript table based on the printer description file and based on the mapping file. The device PostScript table comprising entries associating one or more device feature setting names and one or more corresponding JDF feature names with one or more device command strings which, when executed by a printing system, invokes the device feature setting name. The initialization component is further adapted to transmit the device PostScript table to the printing system. The computing system further comprises a job generator component coupled to receive the device capability file. The job generator component is adapted to generate a JDF job ticket based on user input and based on the information in the device capability file. The job generator component is further adapted to transmit the generated JDF job ticket and associated print job data to the corresponding printing system to generate printed output in accordance with the device PostScript table.

### BRIEF DESCRIPTION OF THE DRAWINGS

The same reference number represents the same element or same type of element on all drawings.

FIG. 1 is a block diagram of an exemplary system enhanced in accordance with features and aspects hereof to utilize a device PostScript table and optional constraint information for improved processing of JDF job tickets.

FIG. 2 is a block diagram of another exemplary system enhanced in accordance with features and aspects hereof to utilize a provided printer description file and mapping file to generate and utilize a device capability file, a device PostScript table, and optional constraint information for improved processing of JDF job tickets.

FIG. 3 is a flowchart depicting an exemplary method in accordance with features and aspects hereof to utilize to utilize a provided printer description file and a provided mapping file to generate and utilize a device capability file, a device PostScript table, and optional constraint information for improved processing of JDF job tickets.

FIG. 4 is a block diagram describing exemplary structure of a mapping file as used in the methods and systems of FIGS. 1 through 3.

FIG. 5 is a flowchart depicting another exemplary method in accordance with features and aspects hereof to utilize to utilize a provided printer description file and a provided mapping file to generate and utilize a device capability file, a device PostScript table, and optional constraint information for improved processing of JDF job tickets.

### DETAILED DESCRIPTION OF THE DRAWINGS

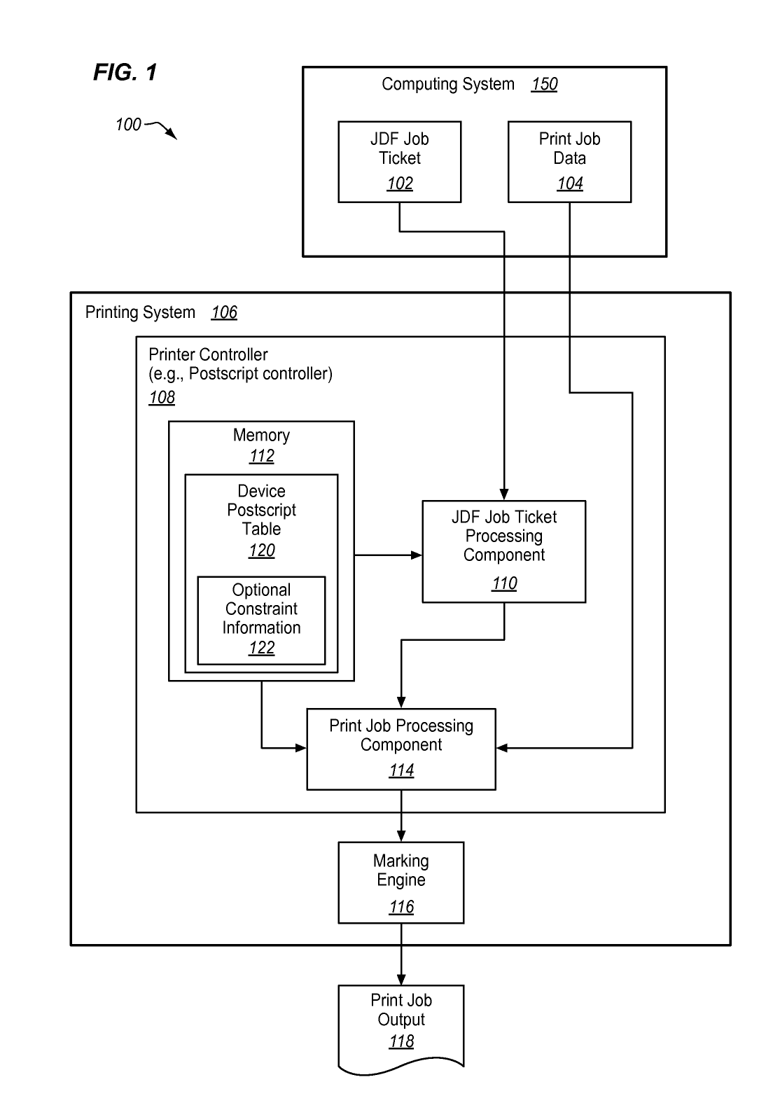

FIGS. 1 through 5 and the following description depict specific exemplary embodiments of the present invention to teach those skilled in the art how to make and use the invention. For the purpose of this teaching, some conventional aspects of the invention have been simplified or omitted. Those skilled in the art will appreciate variations from these embodiments that fall within the scope of the present invention. Those skilled in the art will appreciate that the features described below can be combined in various ways to form multiple variations of the present invention. As a result, the invention is not limited to the specific embodiments described below, but only by the claims and their equivalents.

FIG. 1 is a block diagram of an exemplary system 100 enhanced in accordance with features and aspects hereof to provide improved processing for translation of JDF job tickets within a printing system and to optionally provide for validation of job tickets. System 100 includes computing system 150 and printing system 106. Computing system 150 is adapted to generate a print job comprising a JDF job ticket 102 and associated print job data 104. Computing system 150 transmits the print job to printing system 106 to be processed resulting in print job output 118 (e.g., formatted print job data applied to the desired printable medium substrate.).

Printing system 106 may include marking engine 116. Marking engine 116 may be an electrophotographic marking engine, an ink jet marking engine, or any other device adapted to imprint a sequence of page images on a printable medium such as paper. Printing system 106 receives a print job (ticket 102 and data 104) from computing system 150 and processes the print job to generate page images applied to marking engine 116. Marking engine 116 then imprints the generated page images on the desired printable medium to produce output 118.

Printing system 106 includes printer controller 108. Controller 108 may be any computing device adapted to process received print jobs and typically includes a processing device (e.g., a CPU not shown) and a memory 112. Memory 112 may be any suitable memory device including, for example, magnetic or optical disk drives, DRAM, SDRAM, static RAM, flash memory, or any other memory device suitable for storing information used in the processing of a print job. In one exemplary embodiment, printing system 106 is a PostScript printing system and printer controller 108 is a PostScript printer controller adapted to interpret PostScript command strings.

Printer controller 108 may include JDF job ticket processing component 110 adapted to receive a JDF job ticket 102 from a computing system 150 and adapted to interpret the attributes/elements of the JDF job ticket (e.g., the JDF features and features settings) to generate corresponding device command strings. As generally discussed above, elements or features in a JDF job ticket include a feature name and a setting name for a setting for the named feature. One of the various available settings may be selected as the desired device feature setting name for each element of the job ticket. In general, JDF job ticket processing component 110 is adapted to retrieve each element from the received JDF job ticket 102 and to translate the JDF element into corresponding device command strings (e.g., “device control strings”) based on the contents of device PostScript table 120 stored in memory 112. In one exemplary embodiment discussed further herein below, the device PostScript table 120 is implemented as a PostScript dictionary. In such an embodiment, the “translation” is performed by looking up a key value representing a feature name in the PostScript dictionary. The dictionary entry so located provides the device control string/strings associated with that entry (e.g., derived from the values of the located entry). The device command strings so generated by the translation (e.g., identified by the PostScript dictionary lookup) are then applied to print job processing component 114 within print controller 108 along with the device command strings (e.g., “page image data”) embodied in print job data 104. Print job processing component 114 processes all such device command strings (e.g., the device control strings and the page image data) to generate the desired page images for application to marking engine 116. Further, print job processing component 114 is adapted to assure proper ordering/sequencing of the device command strings with respect to one another and with respect to the print job data 104 to generate the proper output as defined by the job ticket 102 and the print job data 104.

In one exemplary embodiment, printer controller 108 also includes constraint information 122 stored in memory 112. JDF job ticket processing component 110 may be further adapted to utilize constraint information 122 to determine whether any specified combination of JDF elements in job ticket 102 gives rise to conflicts such that the combination of JDF elements is incapable of invocation on the printing system 106. Thus, constraint information 122 may be used by JDF job ticket processing component 110 to validate the elements of the JDF job ticket 102. If the validation processing of JDF job ticket processing component 110 detects a conflict in the specified JDF elements of the JDF job ticket 102, an error signal may be generated to indicate a reason that the provided print job cannot be successfully processed. Such an error signal may include, for example, returning an error message to the computing system 150 or, for example, generating and printing an error indicator page describing the nature of the error/conflict encountered. In one exemplary embodiment discussed further herein below, the constraint information is implemented as a PostScript dictionary (e.g., as a portion of the device PostScript table 120 or as a separate dictionary data structure). In such an embodiment one or more key values representing a feature name and/or feature setting names are used to locate entries of the dictionary that specify constraints related to feature and setting names. The located constraint information entry is then used to determine of other feature or setting names specified in the job ticket that create a conflict for the printing system 106. More generally, constraint information 112 identifies mutually exclusive groups of JDF feature names and JDF feature setting names.

In one exemplary embodiment where printer controller 108 is a PostScript printer controller, JDF job ticket processing component 110 and print job processing component 114 may be implemented as PostScript programs executed by interpretation of the PostScript interpreter (not shown) of the PostScript printer controller 108. In such an embodiment, memory 112 may be PostScript dynamic memory utilized and managed by the PostScript interpreter for storing the device PostScript table 120 and the optional constraint information 122 and for storing PostScript program command strings and intermediate data utilized by, and generated by the execution of JDF job ticket processing component 110 and print job processing component 114. In other exemplary embodiments where printing system 106 is not a PostScript printing system, JDF job ticket processing component 110 and print job processing component 114 operable within printer controller 108 may be implemented as suitably programmed instructions in accordance with the capabilities of the particular printer controller 108. In like manner, device PostScript table 120 and optional constraint information 122 in memory 112 (in such non-PostScript embodiments) may be implemented as any suitable lookup table or array data structure as generally known to those of ordinary skill in the art.

In one exemplary embodiment device PostScript table 120 and optional constraint information 122 may be generated by computing system 150 and transmitted from computing system 150 to printing system 106 for use by printer controller 108. As discussed further herein below, device PostScript table 120 and optional constraint information 122 are generated based on information in a printer description file and a mapping file (not shown in FIG. 1).

Those of ordinary skill in the art will readily recognize numerous additional and equivalent elements in system 100 and printing system 106. Such additional and equivalent elements are omitted herein for simplicity and brevity of this discussion.

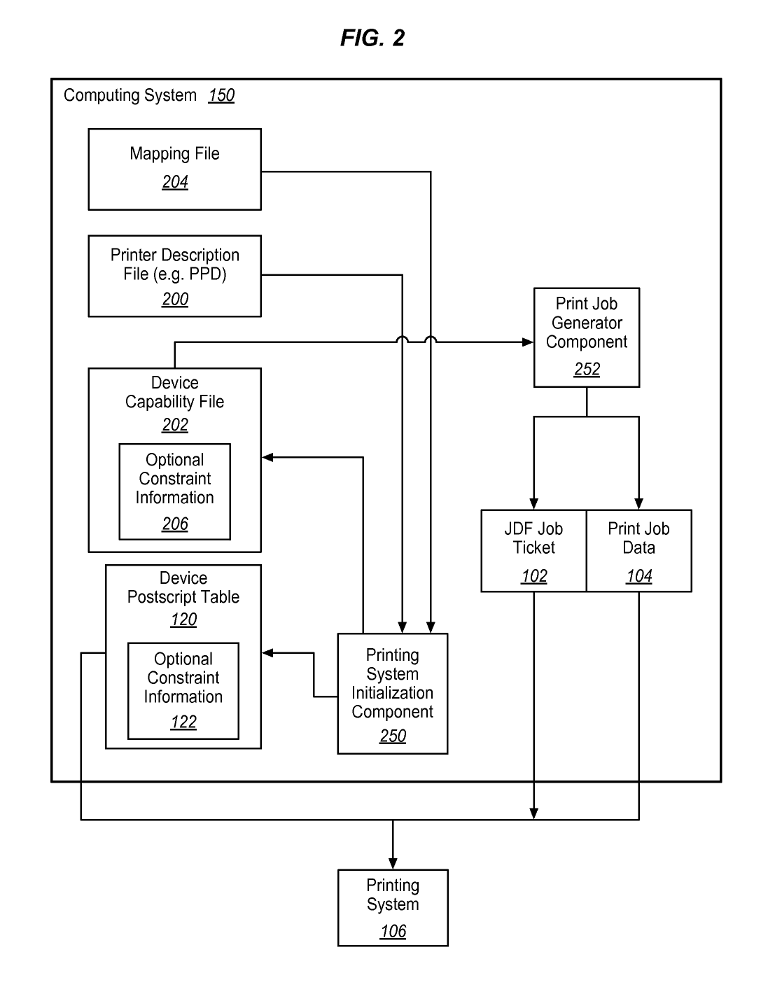

FIG. 2 is a block diagram providing exemplary additional details of computing system 150 adapted to generate files for transmission to printing system 106. Printing system initialization component 250 retrieves information from a provided printer description file 200 (e.g., a PPD file in the context of a PostScript printing system). Information in the printer description file 200 generally includes a device feature setting name for each of the possible option settings available in the corresponding printing system 106 and an associated device command string. For example, in the context of a PostScript printing system, the PPD file may indicate various options such as duplexing on or off, paper input tray option settings, paper output tray option settings, etc. For each device feature setting name in the PPD file 200, a corresponding device command string is associated therewith providing the specific device command to be executed in the printing system 106 to provide the associated desired option for a print job.

In addition, the printer description file 200 may include constraint information specifying particular combinations of device setting feature names that may not be invoked together in processing a print job on the corresponding printing system 106. For example, duplex printing features may be incompatible with other features specifying that an envelope is to be selected from a paper input tray for printing. In such a case, the printer description file 200 may include a constraint specification indicating that such a combination of features may not be invoked together in a valid print job to be sent to printing system 106.

The printing system 150 also includes a mapping file 204 used in conjunction with the PPD file 200 to aid in translating between the JDF feature and setting naming conventions and the feature and setting names in the manufacturer's PPD file 200. Details of the mapping file structure and its use are presented further herein below.

Based on the information in the printer description file 200 and the mapping file 204, printing system initialization component 250 may generate a device capability file 202 in accordance with the JDF defined standards. Device capability file 202 generally provides a list of available device feature setting names for printing system 106 to be presented to a user for generating a desired print job. Each available device feature setting name derived from the printer description file 200 may be transformed into an appropriate format in the device capability file 202 for use by print job generator 252 to interact with a user for defining particular options to be applied to a particular print job. In one exemplary embodiment, printing system initialization component 250 generates information in the device capability file 202 that associates one or more device feature setting names located in the printer description file 200 with one or more corresponding JDF feature names to thereby allow the print job generator 252 to generate a JDF job ticket 102 specifying the particular features settings to be applied when printing corresponding print job data 104. Examples of a generated device capability file are discussed further herein below. Print job generator 252 may then present only the available features/capabilities of the printing system 106 in a user interface to permit a user to select desired options. Print job generator 252 then generates appropriate JDF elements into a JDF job ticket 102 for printing of the associated print job data 104.

In one exemplary embodiment, printing system initialization component 250 may also generate constraint information 206 in device capability file 202 to specify combinations of JDF features that may not be utilized together. Exemplary additional details of the constraint information 206 are presented herein below.

In one exemplary embodiment, printing system initialization component 250 may also utilize information in the printer description file 200 and the mapping file 204 to generate device PostScript table 120. Device PostScript table 120 may include an entry for each feature that may be provided in a JDF job ticket 102 generated by print job generator 252. The entries may then be used in the printing system to translate a JDF feature setting into corresponding device command strings.

In another exemplary embodiment, printing system initialization component 250 may also generate constraint information 122 based on constraint information provided in the printer description file 200 and the mapping file 204. Exemplary additional details of the constraint information 122 are presented herein below.

The device PostScript table 120 with the optional constraint information 122 so generated by printing system initialization component 250 may then be transmitted to the printing system 106.

As described above with reference to FIG. 1, printing system 106 receives JDF job ticket 102 and print job data 104 generated by print job generator 252 in computing system 150 and processes the associated print job in accordance with the device PostScript table 120 and, optionally, in accordance with constraint information 122.

Those of ordinary skill in the art will readily recognize numerous additional and equivalent elements in a computing system 150. Such additional and equivalent elements are omitted herein for simplicity and brevity of this discussion.

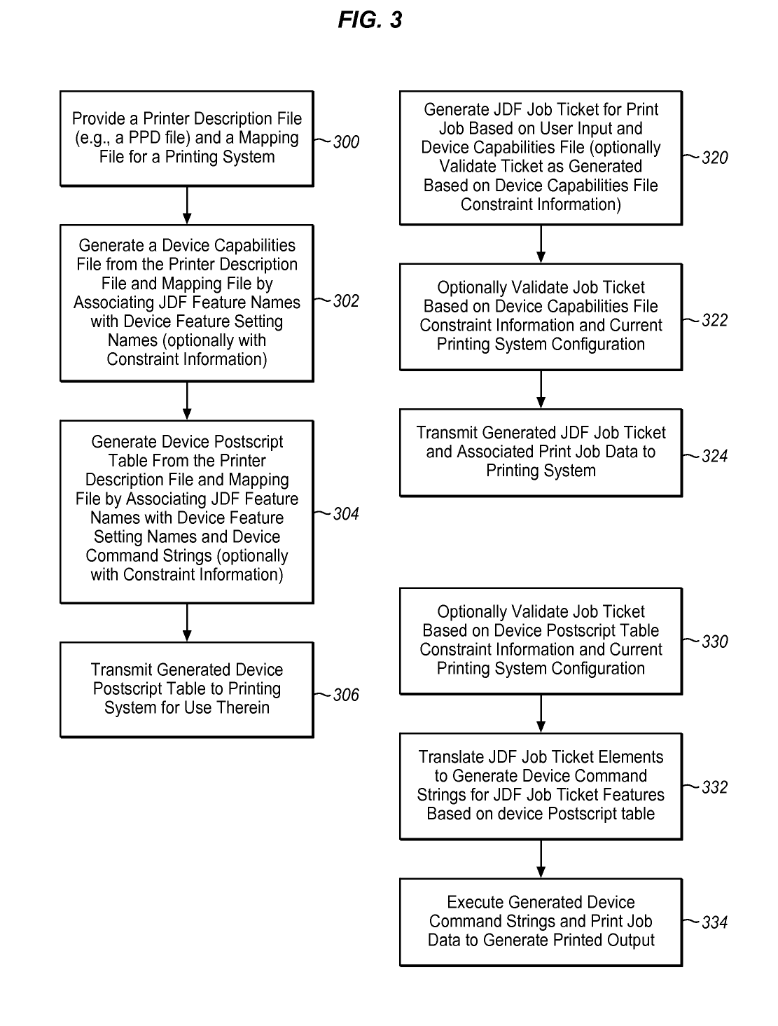

FIG. 3 is a flowchart of exemplary methods in accordance with features and aspects hereof to improve processing of JDF job tickets within a printing system. The methods of FIG. 3 may be operable in components of a system such as those described in FIGS. 1 and 2. As discussed further herein below, some of the processing of FIG. 3 may be performed within the computing system coupled with the printing system and other processing of FIG. 3 may be performed within the printing system.

Steps 300 through 306 represent initialization processing to generate a device capability file and a device PostScript table (each optionally including constraint information). Step 300 provides a printer description file (e.g., a PPD file) corresponding to a particular printing system and a mapping file. As noted above, a PPD file generally provides device feature setting names and corresponding device command strings to be executed by the printing system to invoke the corresponding device feature setting name. In addition, as noted above, a PPD file may also include constraint information indicating combinations of device feature setting names that may not be invoked together by the printing system in processing of a particular print job. The provided mapping file aids in mapping/translating between JDF feature and setting names and corresponding PPD features and settings. Further details of the structure and use of the mapping file are provided herein below.

Step 302 generates a device capability file based on information in the provided printer description file and the mapping file. The generated entries of the device capability file associate one or more JDF feature names with one or more of the available device feature setting names located in the printer description file based on information in the mapping file. In one exemplary embodiment, the generated device capability file may include constraint information used to validate generated JDF job tickets. The constraint information in the device capability file is derived from corresponding constraint information in the PPD file mapped/translated in accordance with information in the mapping file.

Step 304 generates a device PostScript table based on information in the provided printer description file and the mapping file. Generated entries in the device PostScript table map JDF feature names and corresponding feature setting names to one or more device command strings to be performed by the printing system to implement the corresponding JDF feature. The table entries are defined based on information in the PPD file and the mapping file. In one exemplary embodiment, the generated device PostScript table may include constraint information used in the printing system to validate a generated JDF job ticket received in the printing system. The constraint information is derived from corresponding constraint information in the PPD file mapped/translated in accordance with information in the mapping file.

Step 306 transmits the generated device PostScript table to the printing system for use therein to validate and/or execute received JDF job tickets. The device PostScript table is utilized by the printing system (i.e., the printing system controller) to improve the performance of translating JDF elements in a received JDF job ticket into corresponding device command strings. For example, where the device PostScript table is provided as a PostScript dictionary data structure, one or more table/dictionary lookup processes utilizing the device PostScript table in the printing system locates the JDF feature name and thereby translates the desired JDF feature in the JDF job ticket into the corresponding one or more device command strings.

Steps 300 through 306 are performed on a computing system coupled with the printing system such as system 150 described above with reference to FIGS. 1 and 2.

Steps 320 through 324 represent processing within a computing system coupled with the printing system to generate a print job comprising print job data and an associated JDF job ticket and to forward the generated print job (ticket and related data) to the printing system to be executed. Where optional constraint information is provided in the device capability file, the generated JDF job ticket may also be validated by the computing system to assure that it may be executed by the printing system.

Step 320 generates a JDF job ticket in the computing system for a desired print job based on received user input selecting desired options from the generated device capability file. The computing system may present available features to a user based on the device capability file entries and may receive user input selecting a desired set of features to be invoked when printing the print job. In one exemplary embodiment where constraint information is provided as a part of the device capability file, step 320 may also validate the JDF job ticket as it is generated by the processing of step 320. The constraint information in the device capability file indicates combinations of JDF features and setting that cannot be combined in a single print job to be executed by the printing system. Thus, step 320 may use the constraint information to validate that a generated JDF job ticket may be executed by some possible configuration of the printing system and its various optional configurations.

For any of various reasons, the print job represented by the generated job ticket could be queued for later submission to the printing system. For example, the generated print job could simply be at the end of a lengthy list of queued jobs. Of, for example, the newly generated print job could be specified to commence execution at some future time. Thus, the configuration of the printing system could change between the time the job ticket is first generated and the time the printing system is actually ready to commence execution of the print job. Step 322 thus represents optional processing to again validate the generated job ticket just prior to transmission of the generated print job ticket to the printing system. Step 324 then transmits the generated JDF job ticket and any associated print job data to the printing system to permit the defined print job to be imprinted by the printing system in accordance with the JDF job ticket elements.

It will be noted by those of ordinary skill in the art that the validation performed while generating the job ticket (i.e., in step 320) may simply validate that the generated job ticket is capable of being processed on some possible configuration of the printing system. By contrast, the ticket validation performed by step 322 may validate that the generated job ticket is capable of being executed on the present configuration of the printing system. The constraint information in the device capability file may therefore include query operations to be executed by the printing system to determine the present configuration of the printing system just prior to transmission of the generated print job ticket to the printing system.

Steps 330 through 334 are then performed by the printing system in response to receipt of the print job (i.e., receipt of the print job ticket and the related print data). Step 330 may again validate the received job ticket to confirm that the features/settings specified in the job ticket may be executed by the printing system in its present configuration and its present operational state. If so, step 332 translates the elements of the JDF job ticket into corresponding device command strings based on the entries of the device PostScript table stored in the printing system. For each element in the JDF job ticket, step 330 processes the feature name provided in the JDF job ticket to locate one or more corresponding entries of the device PostScript table. Step 334 then executes the device command strings (e.g., “device control strings”) derived from the JDF job ticket translation using the device PostScript table and the device command strings (e.g., page image data) in the received print job data to generate the page images to be printed.

The device command strings derived from the JDF job ticket translation process may include ordering/sequencing information used by the printing system to determine the proper time to execute the device command strings relative to the print data supplied with the job ticket and relative to other device command strings generated by processing of the received job ticket. In general, in some embodiments, the located device command strings from the device PostScript table (i.e., in step 332) may be translated in the sense that they are extracted from the device PostScript table (e.g., based on a PostScript dictionary lookup) and saved for later processing in a proper sequence with the print job data and with other device command strings generated from the job ticket processing. In other embodiments, the JDF feature-setting values may be saved and used later (i.e., in step 334) to process (e.g., locate or translate) corresponding device command strings to be executed as the print job is processed to render the page images.

The validation process as performed in the printing system based on constraint information in the device PostScript table may be more fully understood by way of a simple example of such constraint information. A printer description file (e.g., PPD file) may contain entries for a device feature name and a device feature setting name that may not be combined with another combination of a device feature name and a device feature setting name. For example, a printer description file may include the following two exemplary entries:

*UIConstraint: *FeatureA SettingB *FeatureC SettingD
*UIConstraint: *FeatureA SettingB *FeatureE SettingF

These entries indicate that device feature name “FeatureA”, when set to device feature setting name “SettingB”, cannot be combined in a print job with feature name “FeatureC”, when set to setting name “SettingD” or with feature name “FeatureE”, when set to setting name “SettingF”. This information may then be used as discussed above and as detailed further below to generate constraint information to be sent to the printing system as part of the device PostScript table. As noted in one exemplary embodiment, the constraint information may be implemented in the device PostScript table as a PostScript dictionary (e.g., an example of a key-value table structure). For each pair of conflicting feature-setting values encountered in the printer description file, corresponding entries are created or updated in the constraint information. An entry may, for example, include a first feature-setting value as a key field and may include a value field that is an array of all other feature-setting values that conflict with the first (key value) feature-setting combination. In some embodiments, additional entries may also be created wherein the second feature-setting value is used as a key field and the corresponding value field contains an array of all other feature-setting values that conflict (e.g., initially the first feature-setting value—i.e., the reverse of the first created entry). Use of such “reverse” entries could speed processing in recognizing an invalid job ticket depending on the order in which features and setting are provided in the ticket. Thus, the above exemplary printer description file constraint entries may be translated into exemplary PostScript dictionary entries as follows:

/FeatureA_SettingB [ FeatureC_SettingD FeatureE_SettingF ]
/FeatureC_SettingD [ FeatureA_SettingB ]
/FeatureE_SettingF [ FeatureA_SettingB ]

The above exemplary dictionary entries indicate simplistic constraints in an abstract form. More generally, constraint information as used within the printing system identifies mutually exclusive groups of JDF feature names and JDF feature setting names.

The following excerpt provides further examples of information stored in a typical printer description file (e.g., a PPD file) as may be used to generate entries in optional constraint information.

*UIConstraints: *InputSlot MultiTray *Duplex DuplexNoTumble
*UIConstraints: *InputSlot MultiTray *Duplex DuplexTumble
*UIConstraints: *Duplex DuplexNoTumble *InputSlot MultiTray
*UIConstraints: *Duplex DuplexTumble *InputSlot MultiTray
*UIConstraints: *Duplex DuplexNoTumble *PageSize A6
*UIConstraints: *Duplex DuplexNoTumble *PageSize B6
*UIConstraints: *Duplex DuplexNoTumble *PageSize HalfLetter
*UIConstraints: *Duplex DuplexNoTumble *PageSize 12×18
*UIConstraints: *Duplex DuplexNoTumble *PageSize Env10
*UIConstraints: *Duplex DuplexNoTumble *PageSize EnvMonarch
*UIConstraints: *Duplex DuplexNoTumble *PageSize EnvC5
*UIConstraints: *Duplex DuplexNoTumble *PageSize EnvC6
*UIConstraints: *Duplex DuplexNoTumble *PageSize DLEnv
*UIConstraints: *Duplex DuplexNoTumble *InputSlot MultiTray
*UIConstraints: *Duplex DuplexNoTumble *MediaType Labels
*UIConstraints: *Duplex DuplexNoTumble *MediaType OHP
*UIConstraints: *Duplex DuplexNoTumble *MediaType Thick2
*UIConstraints: *Duplex DuplexNoTumble *MediaType Thick3
*UIConstraints: *Duplex DuplexNoTumble *MediaType Thin
*UIConstraints: *Duplex DuplexNoTumble *PageRegion A6
*UIConstraints: *Duplex DuplexNoTumble *PageRegion B6
*UIConstraints: *Duplex DuplexNoTumble *PageRegion HalfLetter
*UIConstraints: *Duplex DuplexNoTumble *PageRegion 12×18

The following excerpt shows portions of an exemplary constraint information generated as a PostScript dictionary data structure from portions of the above exemplary printer description file.

```
userdict /Constraints <<
/Sides_TwoSidedFlipY
    [/PageSize_A6 /PageSize_B6 /PageSize_HalfLetter /
    PageSize_12×18
    /PageSize_Env10 /PageSize_EnvMonarch /PageSize_EnvC5
    /PageSize_EnvC6 /PageSize_DLEnv /InputSlot_MultiTray
    /MediaType_Labels /MediaType_OHP /MediaType_Thick2
    /MediaType_Thick3 /MediaType_Thin /PageRegion_A6 /
    PageRegion_B6
    /PageRegion_HalfLetter /PageRegion_12×18]
/InputSlot_MultiTray
    [/Sides_TwoSidedFlipX /Sides_TwoSidedFlipY /
    StitchType_UpperLeft
    /StitchType_UpperRight /StitchType_LowerLeft /
    StitchType_LowerRight
    /StitchType_LeftW /StitchType_RightW /
    StitchType_UpperW
    /StitchType_LowerW /StitchType_CenterW /HoleType_Left2
    /HoleType_Left3 /HoleType_Left4 /HoleType_Right2 /
    HoleType_Right3
    /HoleType_Right4 /HoleType_Upper2 /HoleType_Upper3 /
    HoleType_Upper4
    /HoleType_Lower2 /HoleType_Lower3 /HoleType_Lower4]
>> put
```

As noted above, the device PostScript table may include ordering information to assure proper sequencing of execution of the device command strings generated by translating the job ticket. The feature-setting combinations in the job ticket may be re-ordered to assure proper sequencing of the execution of the corresponding device command strings. This helps assure that execution of the device command strings does not improperly defeat a desired option because a later executed device command string (executed in an improper order) overrides the option of an earlier executed device command string (executed in the improper order).

In one exemplary embodiment, ordering information may be provided in the printer description file. This ordering information may express, for example, a required order of processing for the available device feature names specified by the description file. For example, the printer description file may contain entries such as:

*OrderDependency: 200 AnySetup *RICollate
*OrderDependency: 10 AnySetup *RIPaperPolicy
*OrderDependency: 20 AnySetup *PageSize
*OrderDependency: 25 AnySetup *PageRegion
*OrderDependency: 30 AnySetup *InputSlot
*OrderDependency: 50 AnySetup *Duplex

Such entries in the printer description file may be used to generate another table (e.g., PostScript dictionary) for use in the printer's processing of the JDF job tickets. Once the print job processor in the printing system has built the list of concatenated feature-setting names by processing JDF elements of the job ticket, it will consult this table using just the feature name to determine the order in which feature-setting names should be invoked from the device PostScript table. An exemplary table structure (e.g., PostScript dictionary) generated from the above exemplary entries the printer description file may be as follows

```
userdict /OEM1OrderDependencies <<
    /RICollate 200
    /RIPaperPolicy 10
    /PageSize 20
    /PageRegion 25
    /InputSlot 30
    /Duplex 50
>> put
```

Those of ordinary skill in the art will readily recognize a variety of additional and equivalent method steps that may be present in the methods exemplified by FIG. 3. Such additional and equivalent steps are omitted herein for simplicity and brevity of this discussion. Further, those of ordinary skill in art will recognize that the methods of FIG. 3 may be implemented (as a matter of design choice) as suitably programmed instructions executed by a general or special purpose processor in components of, for example, the system of FIGS. 1 and 2, or may be implemented as suitably designed custom circuits to provide the specified functions.

### Mapping File

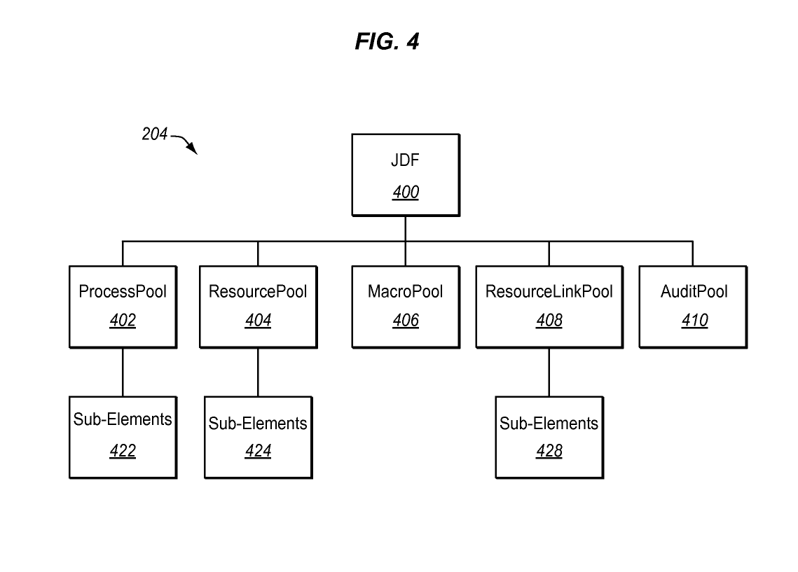

The mapping file (204 of FIG. 2) is important to the function of the steps of the method of FIG. 3. FIG. 4 is a block diagram generally describing the structure of the mapping file. The mapping file 204 is preferably implemented using an XML format. This is convenient because the JDF standard also uses the XML format and there are many tools and programming language facilities available for XML processing. Those of ordinary skill will readily recognize that other formats for the mapping file are possible. For the same reason, it is convenient to first parse the PPD file into an equivalent XML format before processing it in conjunction with the mapping file. Thus, the two inputs to the process of FIG. 3 are both XML files.

The mapping file 204 of FIG. 4 has a structure with some similarity to a JDF job tickets. The top-level tag (element) of the mapping file is JDF 400, and may comprise five sub-elements (child elements) as follows:
ProcessPool 402—lists the JDF processes to be supported by the printing system and indicates which features are needed by each JDF process; used to create the device PostScript table
MacroPool 406—contains default device-independent macros and will be supplemented by device-dependent macros when the PPD is processed
AuditPool 410—data structure which will be copied into job ticket to track workflow
ResourcePool 404—maps structure of JDF ResourcePool to PPD features
ResourceLinkPool 408—maps structure of JDF ResourceLinkPool to PPD features

ResourcePool 404 and ResourceLinkPool 408 may have child elements with the same names as in a JDF job ticket, but the attributes of an element in a JDF job ticket may be instead expressed as sub-elements in the mapping file. These sub-elements corresponding to JDF attributes may themselves contain one or more sub-elements named “PPDFeature” or “JDFFeature”. Sub-elements 422 in the ProcessPool 402 may also contain PPDFeature and JDFFeature elements, which refer to corresponding PPDFeature and JDFFeature elements in ResourcePool (sub-elements 424) or ResourceLinkPool (sub-elements 428).

PPDFeature elements (in sub-elements 422, 424, or 428) describe device-specific features that may occur in a PPD file. A PPDFeature element (sub-element) has two attributes, “Name” and “OEM”. The Name attribute is the name of the PPD feature as it occurs in the PPD file. The OEM refers to the manufacturer (Original Equipment Manufacturer) of the device and functions as a name space declaration. This OEM attribute designation may be useful where names used in PPD files for common device features may differ between manufacturers or between sets (or generations) of device models from a single manufacturer, but they generally fall into families of naming conventions. The OEM attribute of a PPDFeature element indicates the family of names to which this PPDFeature belongs. Thus, by including multiple PPDFeature elements in each location, the mapping file can describe the PPD-to-JDF mapping for multiple families of PPD names.

PPDFeature elements may also have child elements named “Setting” that have attributes named “PPD”, “JDF”, and optionally “PS”. These “Setting” elements map JDF values to one or more PPD device settings and also to PostScript procedures as necessary.

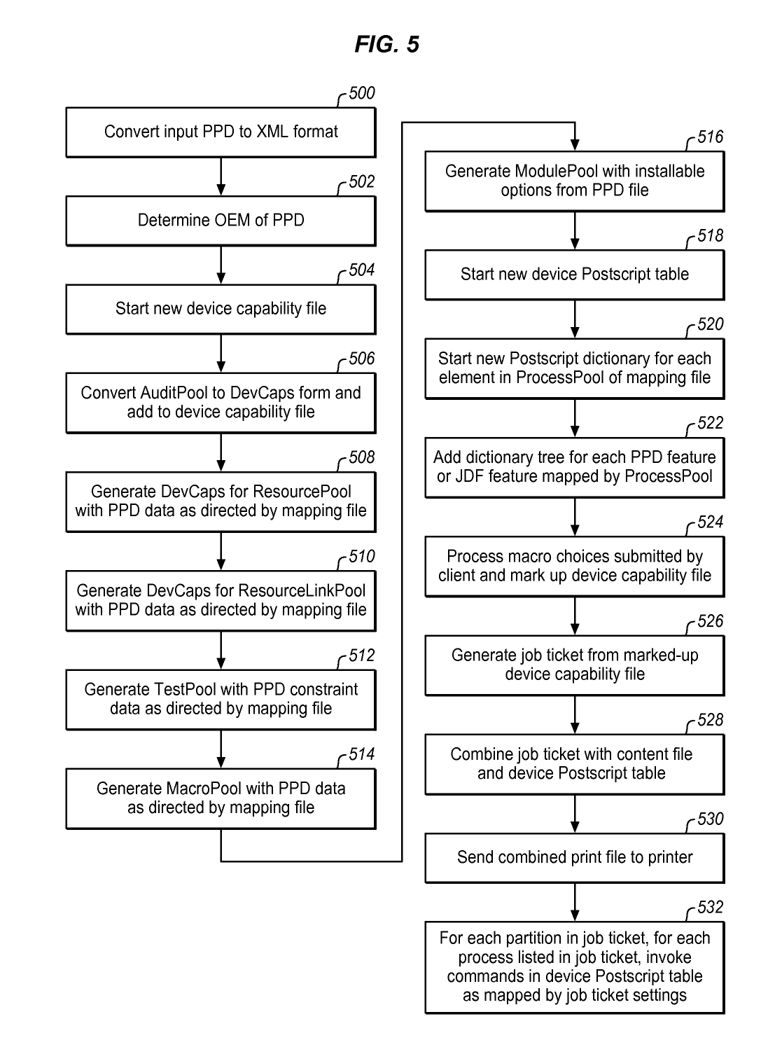

FIG. 5 is a flowchart depicting another exemplary method in accordance with features and aspects hereof to improve processing of JDF job tickets within a printing system. The method of FIG. 5 describes several steps as they relate to the portions of the mapping file structure discussed above in FIG. 4. The method of FIG. 5 may be operable in components of a system such as those described in FIGS. 1 and 2. As discussed further herein below, some of the processing of FIG. 5 may be performed within the computing system coupled with the printing system and other processing of FIG. 5 may be performed within the printing system.

Step 500 converts a provided PPD file into an XML format to ease processing the PPD in conjunction with an XML formatted mapping file to generate an XML formatted device capability file. In one exemplary embodiment, the converted PPD file may be represented in a memory as an XML tree structure. Step 502 determines what, if any, OEM is specified in the PPD file (e.g., as converted to an in memory XML tree structure). The OEM identifier may be used to select among the various entries of the mapping file for use in generating the appropriate device capability file and device PostScript table for the particular printing system to be used. Step 504 then creates a new device capability file for the identified printing system.

Steps 506 through 510 process information in corresponding sections of the mapping file. Specifically, step 506 processes the AuditPool (element 410 of FIG. 4), step 508 processes the ResourcePool (element 404 of FIG. 4), and step 510 processes the ResourceLinkPool (element 408 of FIG. 4). Step 512 processes the PPD file and mapping file to generate a TestPool (described further below) in the device capability file. Step 514 processes the PPD file and mapping file to generate a MacroPool (described further below) in the device capability file. Step 516 processes the PPD file and mapping file to generate a ModulePool (described further below) in the device capability file.

Step 518 creates an output file to store the generated device PostScript table. Step 520 starts a new PostScript dictionary data structure in the output file for each element in the ProcessPool (element 402 of FIG. 4) of the mapping file. Step 522 then adds a dictionary tree structure for each PPD feature or JDF feature referenced in the ProcessPool of the mapping file. The generated output file containing the generated device PostScript table (e.g., as one or more PostScript dictionaries) is sent to the printing system to be used therein for processing of JDF job tickets.

Step 524 adjusts entries of the device capability file based on macro choices entered by a user.

Having so generated a device capability file and a device PostScript table sent to the printing system, step 526 represents processing by a user/application to generate a job ticket for a print job using the generated device capability file. The generated JDF job ticket and associated print job data is then combined for processing at step 528 and sent to the printing system at step 530. Step 532 then represents processing within the printing system to process the JDF job ticket and associated print job data to generate the desired printed output.

Elements and use of the mapping file and PPD file for generating a device capability file and a device PostScript table may also be understood with reference to examples of entries of the mapping file and associated exemplary PPD and JDF job ticket entries. The following is an excerpt from an exemplary PPD file for a collate feature in an “OEM2” manufacturer printing system.

*OpenUI *EFSort/Collate:PickOne
*OrderDependency: 40.0 AnySetup *EFSort
*DefaultEFSort: Collate
*EFSort False/Off: “ /XJXsetcollate where { pop false XJXsetcollate } if
/XJXsetsorter where { pop 0 XJXsetsorter } if ”
*End
*EFSort Collate/On: “ /XJXsetcollate where { pop true XJXsetcollate } if
/XJXsetsorter where { pop 3 XJXsetsorter } if ”
*End
*CloseUI: *EFSort

The following XML represents an exemplary portion of a mapping file for a collate feature including the “OEM2” collate feature and that of another exemplary OEM (e.g., “OEM1”). The “Setting” attributes for each OEM's PPD feature specify PostScript command strings (“PS” attributes) for the corresponding collate features.

```
<JDF>
  <ResourcePool>
    <DigitalPrintingParams>
      <Collate>
        <PPDFeature Name=“RICollate” OEM=“OEM1”>
          <Setting PPD=“False” PS=“false SetCollate” JDF=“None”/>
          <Setting PPD=“True” PS=“true SetCollate” JDF=“Sheet”/>
        </PDFFeature>
        <PPDFeature Name=“EFSort” OEM=“OEM2”>
          <Setting PPD=“False” PS=“false SetCollate” JDF=“None”/>
          <Setting PPD=“Collate” PS=“true SetCollate” JDF=“Sheet”/>
        </PPDFeature>
      </Collate>
    </DigitalPrintingParams>
  </ResourcePool>
</JDF>
```

An exemplary JDF job ticket may specify use of a collate feature as in the following JD job ticket excerpt.

```
<JDF>
    <ResourcePool>
        <DigitalPrintingParams Collate=“Sheet”/>
    </ResourcePool>
</JDF>
```

The exemplary mapping file excerpt provided above in conjunction with the above exemplary PPD excerpt (when used by the method of FIG. 3) would then produce the following PostScript code to be executed by an “OEM2” printer.

/XJXsetcollate where { pop true XJXsetcollate } if
/XJXsetsorter where { pop 3 XJXsetsorter } if true SetCollate

Note that the exemplary generated PostScript code above invoking the device feature has been combined with the code from the “PS” attribute of the PPDFeature for the “OEM2” device. The device-independent code in the “PS” attribute is typically used to inform a layout engine of settings that affect page layout, thus relieving the layout engine of the need to make a device-specific query to the printer hardware to determine the setting. This allows a device-independent layout engine to be deployed for all devices.

Some PPD features do not map one-to-one with JDF features. In some cases, multiple PPD feature options map to a single JDF attribute value. In other cases, multiple JDF attribute values map to the same PPD feature option. The mapping file provides for this by allowing the “PPD” attribute of the “Setting” element to contain multiple PPD feature option names and by allowing “PPDFeature” elements in multiple locations in the mapping file to refer to the same PPD feature. The example below shows how three JDF attributes in ResourcePool and one in ResourceLinkPool map to the “StapleLocation” feature of an “OEM1” printer.

```
<JDF>
  <ResourcePool>
    <StitchingParams>
      <StitchType>
        <PPDFeature Name=“StapleLocation” OEM=“OEM1”>
          <Setting PPD=“UpperLeft UpperRight LowerLeft
LowerRight” JDF=“Corner”/>
          <Setting PPD=“LeftW RightW UpperW LowerW”
          JDF=“Side”/>
          <Setting PPD=“CenterW” JDF=“Saddle”/>
        </PPDFeature>
      </StitchType>
      <Angle>
        <PPDFeature Name=“StapleLocation” OEM=“OEM1”>
          <Setting PPD=“UpperW CenterW LowerW” JDF=“0”/>
          <Setting PPD=“LowerLeft LeftW UpperLeft LowerRight
RightW UpperRight” JDF=“90”/>
        </PPDFeature>
      </Angle>
      <NumberOfStitches>
        <PPDFeature Name=“StapleLocation” OEM=“OEM1”>
          <Setting PPD=“LowerLeft LowerRight UpperLeft
          UpperRight” JDF=“1”/>
          <Setting PPD=“LeftW RightW UpperW LowerW CenterW”
          JDF=“2”/>
        </PPDFeature>
      </NumberOfStitches>
    </StitchingParams>
  </ResourcePool>
  <ResourceLinkPool>
    <ComponentLink>
      <Orientation>
        <PPDFeature Name=“StapleLocation” OEM=“OEM1”>
          <Setting PPD=“UpperLeft LeftW” JDF=“Rotate0”/>
          <Setting PPD=“UpperW UpperRight CenterW”
          JDF=“Rotate90”/>
          <Setting PPD=“RightW LowerRight” JDF=“Rotate180”/>
          <Setting PPD=“LowerW LowerLeft” JDF=“Rotate270”/>
        </PPDFeature>
      </Orientation>
    </ComponentLink>
  </ResourceLinkPool>
</JDF>
```

In order to determine the correct device setting, a job ticket processor must examine all four attributes in a job ticket. The mapping file contains the information that allows mutual exclusions to determine a single staple setting for a particular job ticket. For example, if StitchType=“Corner”, Angle=“90”, NumberOfStitches=“1” and Orientation=“Rotate0”, then the appropriate option for the PPD feature “StapleLocation” is “UpperLeft”.

If a PPDFeature element does not contain any Setting child elements, this indicates that the list of allowed JDF feature settings is to be generated directly from the list of feature settings specified in the PPD file, with the same names and value types. This convention in the interpretation of the mapping file allows sets of names particular to a PPD to be automatically mapped to a specific JDF attribute. It can be used, for example, to map “MediaType” entries from a PPD to the “MediaTypeDetails” attribute of the JDF node /JDF/ResourcePool/Media (as exemplified in the mapping file excerpt below)

```
<JDF>
  <ResourcePool>
    <Media>
      <MediaTypeDetails>
        <PPDFeature Name=“MediaType” OEM=“OEM1”/>
        <PPDFeature Name=“EFMediaType” OEM=“OEM2”/>
        <PPDFeature Name=“MediaType” OEM=“OEM3”/>
      </MediaTypeDetails>
    </Media>
  </ResourcePool>
<JDF>
```

This mapping file structure is useful for large option sets, such as names of media types, that vary widely between printer models and for which the JDF standard has not defined equivalents in all cases. The JDF standard specifically allows for such sets of custom attribute values and thus the mapping file accommodates this with the above exemplary structure.

PPDFeature elements may also occur in the ProcessPool of the mapping file. In this case, the elements indicate which PPD features must be invoked for each process supported by the mapping file. The following mapping example excerpt specifies that the “ColorSpaceConversion” process invokes the PPD feature “ColorModel” for “OEM1” printers and invokes the PPD feature “EFColorMode” for “OEM2” printers.

```
<JDF>
  <ProcessPool>
    <ColorSpaceConversion>
      <Partition Name=“ColorantControl”/>
      <PPDFeature Name=“ColorModel” OEM=“OEM1”/>
      <PPDFeature Name=“EFColorMode” OEM=“OEM2”/>
    </ColorSpaceConversion>
  </ProcessPool>
</JDF>
```

The JDFFeature element (sub-elements) describes a device-independent feature that is not listed in the PPD file but is instead implemented by a PostScript procedure. This is different from the PostScript contained in the “PS” attribute of a PPDFeature element, which supplements the device commands for that feature.

JDFFeature elements that occur in ResourcePool or ResourceLinkPool in the mapping file correspond to JDF features that occur at the equivalent location in a job ticket. These JDFFeature elements may contain “Setting” child elements that have a “JDF” attribute and optionally a “PS” attribute. The “JDF” attribute indicates an allowed setting value for the JDF feature; the optional “PS” attribute may contain a PostScript array with two elements: an integer and a procedure that implements the feature. The integer is the command order number and functions in the same way as the command order number for PPD features. The integer order number indicates when the PostScript procedure should be executed relative to other commands and procedures. In the following exemplary mapping file excerpt, the order number is 1000 for the “SetSizePolicy” procedure.

```
<JDF>
  <ResourcePool>
    <LayoutPreparationParams>
      <FitPolicy>
        <SizePolicy>
          <JDFFeature>
            <Setting JDF=“ClipToMaxPage” PS=“[1000 {/Clip
                  SetSizePolicy}]”/>
            <Setting JDF=“FitToPage” PS=“[1000 {/Fit
                  SetSizePolicy}]”/>
            <Setting JDF=“ReduceToFit” PS=“[1000 {/Reduce
                  SetSizePolicy}]”/>
          </JDFFeature>
        </SizePolicy>
      </FitPolicy>
    </LayoutPreparationParams>
  </ResourcePool>
</JDF>
```

If the value of the “JDF” attribute of the “JDFFeature” element is “INTEGER”, it indicates that the value found in the job ticket will be a single integer that must be passed as a parameter on the PostScript stack to the procedure in the array. If the value of the “JDF” attribute is “XYPAIR” it indicates that the value found in the job ticket will be a pair of real numbers that must be passed as parameters to the PostScript procedure in the array. If the value of the “JDF” attribute is “STRING” it indicates that a string value from the job ticket will be passed to the PostScript procedure. The following exemplary mapping file excerpt shows how the number of copies is set with an integer attribute value.

```
<JDF>
  <ResourceLinkPool>
    <ComponentLink>
      <Amount>
        <JDFFeature>
          <Setting JDF=“INTEGER” PS=“[1000 {SetNumCopies}]”/>
        </JDFFeature>
      </Amount>
    </ComponentLink>
  </ResourceLinkPool>
</JDF>
```

If the “JDFFeature” element has no “PS” attribute, this indicates that there is no procedure to be executed at print time. However, the value of the “JDF” attribute may be used by another module in the system. In the following exemplary mapping file excerpt, the “ComponentType” attribute is not needed by the job ticket processor but may be referenced by another module in the printing system, such as a job scheduler.

```
<JDF>
  <ResourcePool>
    <Component>
      <ComponentType>
        <JDFFeature>
          <Setting JDF=“FinalProduct”/>
          <Setting JDF=“PartialProduct”/>
        </JDFFeature>
      </ComponentType>
    </Component>
  </ResourcePool>
</JDF>
```

JDFFeature elements may also occur in the ProcessPool of the mapping file. In this case, they have no “Setting” children and just one attribute: a “Path” attribute that has the value of a JDF pathname that identifies the corresponding attribute in a job ticket. This informs the ticket processor that the attribute must be consulted when executing the process that corresponds to the process child element of the ProcessPool in which the JDFFeature element occurred. The following exemplary mapping file excerpt shows how the mapping file indicates that the “SetNumCopies” procedure (as exemplified above) must be invoked as part of the “DigitalPrinting” process.

```
<JDF>
  <ProcessPool>
    <DigitalPrinting>
      <Partition Name=“DigitalPrintingParams”/>
      <JDFFeature Path=“ResourceLinkPool/ComponentLink/Amount”/>
    </DigitalPrinting>
  </ProcessPool>
</JDF>
```

### Device Capability File

The device capability description format (DevCaps) specified in the JDF documentation can serve several purposes. A DevCaps file can present a set of features available on the device as an API for a client and contain logic to map these features to constructs in a JDF job ticket (MacroPool). Further, it may include a set of tests to check feature settings for conflicts (TestPool). In addition, the DevCaps file may include a description of optional configurations of the device which affect which features are available (ModulePool) and finally. Still further, it can serve as a template for the generation of job tickets (via use of the CurrentValue attribute). The mapping file described here supports all of these use cases for generating a device capability file.

PPD features are generally mapped to elements in the ResourcePool of a job ticket. Such elements are modeled in a DevCaps file by DevCaps elements with the attribute “Context” set to the value “Resource”. ResourceLinkPool elements are modeled by DevCaps elements with Context set to “Link”. These two sets of elements can be produced by software modules that use the PPD file and the mapping file as input. The algorithmic logic of these modules is described below. It is assumed that the OEM has already been determined, either by examining characteristics of the PPD file or by directly setting a value in a configuration file (also used as input to the algorithms discussed below).

A CIP4 device capability file starts with a “DeviceInfo” root node, which has a “Device” element as a child, which, in turn, has a “DeviceCap” child element, which, in turn, contains one or more “DevCaps” elements. Each “DevCaps” element has a “DevCap” child element, which, in turn, has one or more child elements (such as EnumerationState or IntegerState) that represent attributes in a job ticket.

### DevCaps for ResourcePool

The following example excerpt shows a single DevCaps element for the “Media” element and its child DevCap element for the “Location” attribute, which is how a JDF job ticket indicates the input tray to be used on a device:

```
<DevCaps Context=“Resource” Name=“Media”>
  <DevCap Name=“Media”>
    <EnumerationState Name=“LocationName”
      AllowedValueList=“Tray-1 Tray-2 Tray-3”/>
  </DevCap>
</DevCaps>
```

The preceding DevCaps example excerpt is mapped by the following exemplary excerpt of a mapping file (note that it specifies more input tray names than actually occur in the DevCap).

```
<JDF>
  <ResourcePool>
    <Media>
      <Location>
        <LocationName>
          <PPDFeature Name=“InputSlot” OEM=“OEM1”>
            <Setting PPD=“MultiTray” JDF=“BypassTray”/>
            <Setting PPD=“1Tray” JDF=“Tray-1”/>
            <Setting PPD=“2Tray” JDF=“Tray-2”/>
            <Setting PPD=“3Tray” JDF=“Tray-3”/>
            <Setting PPD=“4Tray” JDF=“Tray-4”/>
            <Setting PPD=“5Tray” JDF=“Tray-5”/>
            <Setting PPD=“6Tray” JDF=“Tray-6”/>
            <Setting PPD=“7Tray” JDF=“Tray-7”/>
          </PPDFeature>
        </LocationName>
      </Location>
    </Media>
  </ResourcePool>
</JDF>
```

As noted, not all of the tray names in the mapping file show up in the device capability file, only the ones matching names found in the corresponding feature in the exemplary PPD file excerpt, shown here:

```
*OpenUI *InputSlot: PickOne
*OrderDependency: 30 AnySetup *InputSlot
*DefaultInputSlot: 1Tray
*InputSlot 1Tray/Tray 1: “<</MediaPosition 1>> setpagedevice”
*InputSlot 2Tray/Tray 2: “<</MediaPosition 2>> setpagedevice”
*InputSlot 3Tray/Tray 3: “<</MediaPosition 3>> setpagedevice”
*?InputSlot: “
  save
  [(MultiTray)(1Tray)(2Tray)(3Tray)(4Tray)]
  statusdict /papertray get exec {get}stopped
  {pop pop (Unknown)}if = flush
  restore
”
*End
*CloseUI: *InputSlot
```

The above exemplary excerpts show how the device capability file is constructed by using the mapping and filtering information from the PPD file according to the mapping file. The following algorithm more fully describes the method for generating elements in a device capability file for the ResourcePool elements using the mapping file and the PPD file.

| | |
|---|---|
| 1. | Iterate for all children nodes of the mapping file node “/JDF/ResourcePool” |
| 2. | For each child node, start a DevCaps element in the output XML file |
| 3. | Set the Name attribute to the child's name and the Context attribute to “Resource” |
| 4. | Set the ID and Status attributes to default settings as desired |
| 5. | Start a “DevCap” child node of the DevCaps element with the same name attribute |
| 6. | Pass child node from mapping file and pass output file as parameters to recursive |
| | function which: |

| | |
|---|---|
| a. | Iterates for all children nodes of the passed-in node parameter |
| b. | If the child node is a PPDFeature element, use the value of the “Name” |
| | attribute to find the feature in the PPD file, abort if the PPD has no options |
| | for the feature |
| c. | Get the first child element of the PPDFeature map node (Setting), if found: |

| | |
|---|---|
| i. | Examine the JDF attribute of the Setting element, if it is |

| | |
|---|---|
| 1. | a single integer, start an “IntegerState” child of the DevCap |
| | and add the attribute “ListType” set to “List” |
| 2. | two integers separated by a space, start an “XYPairState” |
| | child |
| 3. | a name, start an “EnumerationState” child |

| | |
|---|---|
| ii. | Examine the PPD file for a default option for the feature, if found: |

| | |
|---|---|
| 1. | Determine the corresponding JDF name in the mapping file |
| 2. | Output it as the DefaultValue attribute of the State element |

| | |
|---|---|
| iii. | If an EnumerationState, generate the list of the “AllowedValues” |
| | attribute of the State element in the output by looking for the name |
| | of each feature option from the PPD file in the “PPD” attribute of |
| | each Setting child element of the PPDFeature element in the map |
| | and adding the value of the associated “JDF” attribute to the list |
| iv. | End the State element in the output |

| | |
|---|---|
| d. | If the PPDFeature element has no children, generate output from PPD |
| | options: |

| | |
|---|---|
| i. | Start an EnumerationState element in the output |
| ii. | Generate the list for the AllowedValues attribute directly from the |
| | options listed in the PPD file for the feature |
| iii. | Add DefaultValue attribute if default option specified in PPD file |
| iv. | End the State element in the output |

| | |
|---|---|
| e. | If the child of the passed-in node is JDFFeature (instead of PPDFeature), |
| | iterate the child Setting elements and possibly a Default element: |

| | |
|---|---|
| i. | In the first Setting child, check the value of the JDF attribute to |
| | determine the type and start a new element in the output: |
| | IntegerState, XYPairState or EnumerationState as appropriate |
| ii. | If EnumerationState, build the list for the AllowedValues attribute |
| | from the JDF attributes of the Setting children of the JDFFeature |
| | element in the map. |
| iii. | If a Default element sibling of the Setting elements was |
| | encountered, output its value as the DefaultValue attribute of the |
| | State element |
| iv. | End the State element in the output |

| | |
|---|---|
| f. | If the child of the passed-in node is neither JDFFeature or PPDFeature, it |
| | is an intermediate node, so make a recursive call to the current function. |
| | The recursion will continue until a PPDFeature or JDFFeature element is |
| | found. |

| | |
|---|---|
| 7. | End the DevCap element |
| 8. | End the DevCaps element |

### DevCaps for ResourceLinkPool

DevCaps elements modeling elements in the ResourceLinkPool of a job ticket can be derived in two ways: directly from the ResourceLinkPool of the mapping file, and indirectly from the ResourcePool of the mapping file.

DevCaps elements are derived directly from the mapping file's ResourceLinkPool by recursively iterating through all children of the node “/JDF/ResourceLinkPool” in the mapping file until a descendant node is found with either the name “PPDFeature” or “JDFFeature”. The following algorithm more fully describes the method for generating elements in a device capability file for the ResourceLinkPool elements using the mapping file and the PPD file.

| | |
|---|---|
| 1. | If this is the first recursion, (i.e. a direct child of |
| | /JDF/ResourceLinkPool): |

| | |
|---|---|
| a. | Start a new DevCaps element in the output DevCaps file, |
| | copy the Name attribute from the map node, set the Context |
| | attribute to “Link” |
| b. | Start a new DevCap element (child of DevCaps), set same Name |
| | attribute |

| | |
|---|---|
| 2. | If a PPDFeature element is encountered: |

| | |
|---|---|
| a. | Get the Name attribute, abort if it does not occur as a feature |
| | in the PPD file |
| b. | If there are no Setting children of this PPDFeature, skip it |
| c. | Determine the data type from the first Setting child element and |
| | start a new State element in the output as described above |
| | for ResourcePool processing in outline point 6c. |
| d. | Iterate through Setting child elements, collect JDF attribute |
| | values into a list |
| e. | Output collected list as AllowedValuesList attribute of the State |
| | element |
| f. | End the State element |

| | |
|---|---|
| 3. | If a JDFFeature element is encountered: |

| | |
|---|---|
| a. | If there are no children of this JDFFeature, skip it |
| b. | Determine data type from the first Setting or Default child |
| | element as above |
| c. | Iterate through all Setting children of this JDFFeature |
| | (and possibly a single Default child), collect JDF attribute |
| | values into a list. |
| d. | Output collected list as the AllowedValuesList attribute |
| | of the State element |
| e. | If a Default child of the JDFFeature was encountered, output |
| | the value of its JDF attribute as the DefaultValue attribute |
| | of the State element |
| f. | End the State element |

| | |
|---|---|
| 4. | After completion of all recursions, end the DevCap element |
| 5. | End the DevCaps element |

### MacroPool

The “MacroPool” is a child element of the DeviceCap element and a sibling element of the ResourcePool and ResourceLinkPool elements in the device capability file as generated. The MacroPool contains one or more “macro” child elements, each of which contains a “choice” element, which in turn contains one or more “when” elements. A “when” element contains an evaluation element such as “IntegerEvaluation” or “EnumerationEvaluation” and one or more “set” elements, each of which refers to the attribute of an element in the job ticket and specifies a value to which that attribute should be set. The evaluation elements serve to process the parameter passed to the macro and select the appropriate set element. Typically, the set element sets the “CurrentValue” attribute in the DevCaps element that models the target element in the job ticket. This facilitates the generation of a job ticket because the values of the CurrentValue attributes in the DevCaps elements are used to select values for the job ticket.

The macro example excerpt below selects portrait or landscape orientation for the print job, stored in the Rotate attribute of the LayoutPreparationParams element, which is a child of ResourcePool in the job ticket:

```
<macro ID=“Orientation”>
  <choice>
    <when>
      <EnumerationEvaluation ValueList=“Portrait”
      rRef=“PageOrientation”/>
      <set rRef=“JDF.ResourcePool.LayoutPreparationParams.Rotate”>
        <FeatureAttribute CurrentValue=“Rotate0”/>
      </set>
    </when>
    <when>
      <EnumerationEvaluation ValueList=“Landscape”
      rRef=“PageOrientation”/>
      <set rRef=“JDF.ResourcePool.LayoutPreparationParams.Rotate”>
        <FeatureAttribute CurrentValue=“Rotate90”/>
      </set>
    </when>
  </choice>
</macro>
```

The macro in the example above is device-independent, since the page rotation specified can be implemented by a PostScript command on any PostScript-equipped printer. This macro can therefore be included in the MacroPool of the mapping file, which is copied into all device capability file generated from the mapping file (without the need for guidance from the PPD file).

Macros for device-dependent PPD features are derived from the PPD and mapping files. This is the primary mechanism by which a device capability description can present an interface of PPD features to a client and then generate a JDF job ticket that reflects the user's choices. The following macro example excerpt shows a simple macro (with only one choice) generated for the staple feature by the mapping file:

```
<macro ID=“StapleLocation”>
  <choice>
    <when>
      <EnumerationEvaluation ValueList=“UpperLeft” rRef=“ppdm”/>
      <set rRef=“JDF.ResourcePool.StitchingParams.StitchType”>
        <FeatureAttribute CurrentValue=“Corner”/>
      </set>
      <set rRef=“JDF.ResourcePool.StitchingParams.Angle”>
        <FeatureAttribute CurrentValue=“90”/>
      </set>
      <set
      rRef=“JDF.ResourcePool.StitchingParams.NumberOfStitches”>
        <FeatureAttribute CurrentValue=“1”/>
      </set>
      <set rRef=“JDF.ResourceLinkPool.ComponentLink.Orientation”>
        <FeatureAttribute CurrentValue=“Rotate0”/>
      </set>
    </when>
  </choice>
</macro>
```

Thus, there may be two (or more) classes of macros: device-independent and device-dependent. The device-independent macros are specified by the mapping file and copied directly into the generated device capability file. The device-dependent macros implement PPD features and are generated from information in the PPD and mapping files. Assuming the MacroPool element has been started in the output device capability file, this may be accomplished in accordance with the following algorithm:

| | |
|---|---|
| 1. | Recursively iterate through all descendants of the ResourcePool and |
| | ResourceLinkPool elements in the mapping file to find all PPDFeature elements |
| 2. | Collect the values of all the Name attributes of the PPDFeature elements, this |
| | constitutes the list of names of macros to be generated |
| 3. | For each name in the list generated in step 2: |

| | |
|---|---|
| a. | Start a new “macro” element (child of MacroPool) in the output |
| b. | Set the ID attribute to the name being iterated from the list |
| c. | Start a new “choice” element (child of macro) in the output |
| d. | Locate the feature in the PPD file, for each option listed: |

| | |
|---|---|
| i. | Start a “when” element in the output |
| ii. | Add an “EnumerationEvaluation” element in the output |
| iii. | Add a “ValueList” attribute with a value equal to the name of the |
| | option in the PPD file, this ends the EnumerationEvaluation |
| | element |
| iv. | Recursively iterate through all descendants of the ResourcePool |
| | and ResourceLinkPool elements in the mapping file to find all |
| | PPDFeature elements with “Name” attribute equal to the PPD |
| | feature name (there may be multiple such elements); for each one |
| | found: |

| | |
|---|---|
| 1. | Iterate through the “Setting” child elements of the |
| | PPDFeature, search the one or more names in the “PPD” |
| | attribute of the PPDFeature looking for a match with the |
| | name of the option from the PPD file. If a match is found: |

| | |
|---|---|
| a. | Start a “set” element in the output |
| b. | Add an “rRef” attribute with value of the JDF path |
| | that corresponds to the location of the PPDFeature |
| | in the mapping file, e.g. |
| | JDF.StitchingParams. StitchType” |
| c. | Start a “FeatureAttribute” element in the output |
| d. | Add a “CurrentValue” attribute with value of the |
| | “JDF” attribute of the “Setting” element being |
| | iterated |
| e. | End the “FeatureAttribute” element |
| f. | End the “set” element |

| | |
|---|---|
| v. | End the “when” element |

| | |
|---|---|
| e. | End the “choice” element |
| f. | End the “macro” element |

### Macro Processor

Although macro processing does not directly depend on the mapping file that is discussed in this patent application, the concept is explained here briefly because the CIP4 documentation is not clear on how macro choices would be submitted to a process for job ticket creation.

A client application may present a user with a set of choices based on the MacroPool in a device capability file, or may use its own internal logic to determine macro settings for a print job. Either way, the choices made must be passed to a macro processor that sets values in the generated device capability file. The set values can then be subsequently used by a ticket generator to output the actual job ticket. The choices can be easily described by an XML structure containing “Setting” elements, each of which has a “MacroRef” attribute equal to the “ID” attribute of the macro and a “MacroChoice” attribute equal to the “ValueList” attribute of the “EnumerationEvaluation” child element of the “when” element which contains the “set” element that specifies the desired setting. The following is an example macro excerpt that represents the selection of nine parameters:

```
<MacroSettings>
    <Setting MacroRef=“ContentFile” MacroChoice=“SevenPager.pdf”/>
    <Setting MacroRef=“NumCopies” MacroChoice=“7”/>
    <Setting MacroRef=“EFOutputBin” MacroChoice=“Upper”/>
    <Setting MacroRef=“EFMediaType” MacroChoice=“Cardstock”/>
    <Setting MacroRef=“EFDuplex” MacroChoice=“TopBottom”/>
    <Setting MacroRef=“PageSize” MacroChoice=“Letter”/>
    <Setting MacroRef=“EFStapler” MacroChoice=“1UpLeftV”/>
    <Setting MacroRef=“CoverSheetMedia” MacroChoice=“Media#5”/>
    <Setting MacroRef=“EFResolution” MacroChoice=“1200×1200dpi”/>
</MacroSettings>
```

The XML specifying the user's choices is submitted with the device capability file to a macro processing function which performs the following algorithm:

| | |
|---|---|
| 1. | For each “Setting” child element of the “MacroSettings” element: |

| | |
|---|---|
| a. | Iterate through the “macro” elements in the MacroPool of the |
| | device capability file until a macro is found with an “ID” |
| | attribute that matches the “MacroRef” attribute of the “Setting” |
| | element being iterated |
| b. | Get the “choice” child element of the macro |
| c. | Iterate the “when” children of the “choice” element, for each: |

| | |
|---|---|
| i. | Get the “EnumerationEvaluation” child element, compare |
| | value of “ValueList” attribute with the “MacroChoice” |
| | attribute of the “Setting” element being iterated |
| | (in step 1.a), if a match: |

| | |
|---|---|
| 1. | Navigate to the element in the device capability file which |
| | corresponds to the JDF ticket location in the “rRef” |
| | attribute of the “set” child element of the “when” element |
| | which was identified in step 1.c.i |
| 2. | Add (if not present) or set (if present) the “CurrentValue” |
| | attribute of the device capability element to the value of the |
| | “CurrentValue” attribute of the “FeatureAttribute” child |
| | element of the “set” child element in the MacroPool |
| | identified in step 1.c.i |

### TestPool

PPD files may include a construct named “UIConstraint” that lists two pairs of feature and option names that are mutually exclusive. In other words, if the first feature name is set to the first option name, then the second feature name is constrained from being set to the second option name. This is the primary mechanism by which PostScript printer drivers can avoid conflicts in the settings for the print job. Following is an exemplary PPD excerpt that prohibits 11×17 paper (“ledger” size) from being loaded into paper tray #1 (for example, if it physically doesn't fit, thus the prohibition):
*UIConstraints: *InputSlot 1Tray *PageSize 11×17

The CIP4 method of expressing constraints is through the use of an XML data structure called a “TestPool” which contains one or more “Test” elements. Each Test element may contain a single evaluation element, such as EnumerationEvaluation, which has attributes named “ValueList” and “rRef”, the first being a value and the second a location in a JDF job ticket. If the attribute in the named location has the named value, the Test element evaluates to true, otherwise, to false. Alternatively, a Test element may contain multiple evaluation elements grouped under an “and” element, which evaluates to true if and only if all of its evaluation child elements evaluate to true (otherwise it is false), or an “or” element, which evaluates to true if any of its evaluation child elements evaluate to true. The CIP4 equivalent of the exemplary PPD constraint excerpt above would be:

```
<Test ID=“Tray1_11×17”>
    <and>
        <EnumerationEvaluation ValueList=“Tray-1”
    rRef=“JDF.ResourcePool.Media.Location.LocationName”/>
        <EnumerationEvaluation ValueList=“11×17”
                rRef=“JDF.ResourcePool.Media.DescriptiveName”/>
    </and>
</Test>
```

There is no standard convention for the text string used as the Test ID attribute, but the methods described here constructs the ID from a feature and option name, then lists one or more references to other Tests that describe settings which are prohibited if the feature is set to the named option. These methods save space in the TestPool data structure.

The mapping file is used to derive the JDF equivalents of the features and options specified in the PPD constraints. In this method, the TestPool may be created with two parts: the first part defines a set of tests for feature-setting combinations; the second part defines a set of prohibitions that refer to the tests in the first section. The tests in the first part may comprise multiple evaluation elements grouped under an “AND” element. This is because in some cases a single device setting maps to multiple settings in a JDF job ticket. For example, this multiple mapping applies to the case of settings for a staple finisher on a digital printer, for which each individual setting maps to four different values that must be set in a JDF job ticket. Thus, to express a PPD constraint related to a specific stapler setting in terms of the CIP4 standard, it is first necessary to describe a test for that stapler setting that will consist of an “AND” element that contains four different evaluation elements. Then, the constraint can be built as a test that includes a reference to the stapler setting test and any other tests representing prohibited conditions. These test references will be grouped under an “OR” element, because none of them are allowed so if any one of them evaluates to true, then the parent test evaluates to true, which means a conflict has been found and the job ticket is invalid. These tests in the second group are referred to as “exclusions” because they exclude any of the conditions represented by the tests listed from the first group.

Some of the UIConstraint statements in the PPD file do not reference feature settings that can be mapped to JDF equivalents. Rather, they refer to the results of PostScript queries that are specified in the “InstallableOptions” group of the PPD file. While such constraints will be referred to in the second part of the TestPool, they will not have definitions in the first part of the TestPool. Rather, the feature names for these constraints will appear in the ModulePool (described further below), indicating that the device PostScript file has a query referenced by the feature name. In such cases, the host-based client asks the printer to execute the query and return the result to the host so that the name returned in the result can be joined with the feature name (e.g., concatenated with an underscore separator between the names). Processing of the TestPool can then continue as if this feature-setting name were the name of a test in the first part of the TestPool that had evaluated to true.

The following example shows a two-part TestPool with three tests defined in the first part and four exclusion tests defined in the second part. One of the names in the second part, “Finisher_None”, is not defined in the first part because it is the result of a query for an installable option.

```
<TestPool>
    <Test ID=“InputSlot_MultiTray”>
        <StringEvaluation ValueList=“MultiTray”
    rRef=“JDF.ResourcePool.Media.Location.LocationName”/>
    </Test>
    <Test ID=“OutputBin_Standard”>
        <StringEvaluation ValueList=“Tray”
    rRef=“JDF.ResourcePool.DigitalPrintingParams.OutputBin”/>
    </Test>
    <Test ID=“StapleLocation_UpperLeft”>
        <and>
            <StringEvaluation ValueList=“Corner”
    rRef=“JDF.ResourcePool.StitchingParams.StitchType”/>
            <StringEvaluation ValueList=“90”
    rRef=“JDF.ResourcePool.StitchingParams.Angle”/>
            <StringEvaluation ValueList=“1”
    rRef=“JDF.ResourcePool.StitchingParams.NumberOfStitches”/>
            <StringEvaluation ValueList=“Rotate0”
    rRef=“JDF.ResourceLinkPool.ComponentLink.Orientation”/>
        </and>
    </Test>
    <Test ID=“InputSlot_MultiTray_Exclusions”>
        <TestRef rRef=“StapleLocation_UpperLeft”/>
    </Test>
    <Test ID=“OutputBin_Standard_Exclusions”>
        <TestRef rRef=“StapleLocation_UpperLeft”/>
    </Test>
    <Test ID=“Finisher_None_Exclusions”>
        <TestRef rRef=“StapleLocation_UpperLeft”/>
    </Test>
    <Test ID=“StapleLocation_UpperLeft_Exclusions”>
        <or>
            <TestRef rRef=“InputSlot_MultiTray”/>
            <TestRef rRef=“OutputBin_Standard”/>
            <TestRef rRef=“Finisher_None”/>
        </or>
    </Test>
</TestPool>
```

The following algorithm describes processing to generate the TestPool in the device capability file output.

| | |
|---|---|
| 1. | Start the “TestPool” element in the output device capability file as a child of the |
| | “DeviceCap” element (sibling of DevCaps elements). |
| 2. | For each unique feature/option pair in each “UIConstraint” statement in the PPD file: |

| | |
|---|---|
| a. | Call a recursive function to count how many PPDFeature elements in the |
| | ResourcePool and ResourceLinkPool of the mapping file have the feature name |
| | as the value of the “Name” attribute and the option name contained in the PPD |
| | attribute of any of the “Setting” children of the PPDFeature element. |
| b. | If the count of PPDFeatures is greater than zero, start a new “Test” element in |
| | the output device capability file (i.e. tests for unmapped features will not be |
| | output) |

| | |
|---|---|
| i. | Set the “ID” attribute of the “Test” element to the feature and option |
| | names joined together with an underscore |
| ii. | If the count of PPDFeatures is greater than one, start a new “and” |
| | element in the output |
| iii. | Call a recursive function similar to the one used to count relevant |
| | PPDFeature elements in step 2.a., but this time, for each PPDFeature |
| | element's “Name” attribute and “Setting” child element's “PPD” |
| | attribute that contain a match the feature/option pair being searched, |
| | output an evaluation element which has a “ValueList” attribute set to the |
| | value of the “JDF” attribute from the “Setting” element and an “rRef” |
| | attribute set to the pathname of the location of the PPDFeature in the |
| | mapping file. |
| iv. | If the count of PPDFeatures in step 2.b.i was greater than one, end the |
| | “and” element in the output |
| v. | End the “Test” element in the output. |

| | |
|---|---|
| 3. | For each unique feature/option pair in each “UIConstraint” statement in the PPD file: |

| | |
|---|---|
| a. | Start a “Test” element in the output |

| | |
|---|---|
| i. | Set the “ID” attribute of the test element to the feature and option names |
| | joined together with an underscore and append “_Exclusions” to the end |
| ii. | Build a list of all other UIConstraint statements which prohibit this |
| | feature/option pair |
| iii. | If the number of items in the list is greater than one, start an “or” element |
| | in the output |
| iv. | For each UIConstraint statement in the list, output a “TestRef” element |
| | with “rRef” attribute set to a string formed by joining the feature and |
| | option names from the UIConstraint with an underscore such that it will |
| | match an “ID” attribute created in step 2.b.i for the same UIConstraint |
| v. | If an “or” element was started in step 3.a.iii, end the “or” element |
| vi. | End the “Test” element |

| | |
|---|---|
| 4. | End the “TestPool” element |

### ModulePool

Module elements in a CIP4 device capability file specify features that depend on specific hardware or software features being installed. In the case of digital printers, this may include finishers, for example, that provide functions such as stapling, punching, and folding. The availability of modules (whether they are presently installed or not) is described at a different location in the device capability description than the modules themselves. Module elements are children of the “Device” element and siblings of the “DeviceCap” element. The availability of each module is described by a “ModuleCap” element that is a child of the “ModulePool” element, which, in turn, is a child of the “DeviceCap” element. The following is an exemplary excerpt of a Module element generated in a device capability file.

```
<DeviceInfo>
    <Device>
        <Module ModuleID=“Finisher”>
            <Module ModuleID=“Stapler”/>
            <Module ModuleID=“Puncher”/>
        </Module>
        <DeviceCap>
            <ModulePool>
                <ModuleCap Availability=“NotInstalled”
                ModuleID=“Finisher”/>
            </ModulePool>
        </DeviceCap>
    </Device>
</DeviceInfo>
```

Although the construction of the “Module”, “ModulePool” and “ModuleCap” elements do not require the mapping file, the ModuleIDs are referenced by UIConstraint statements, which may also reference features that are mapped, such as the stapling and punching functions.

The modules are generated by first locating the “InstallableOptions” group within the PPD file, adding a “Module” element to the output device capability file for each installable option found in the PPD file, with child “Module” elements for each optional configuration listed in the PPD. The “ModuleID” attribute of the parent “Module” element has the value of the feature name in the PPD and the “ModuleID” attributes of the child “Module” elements have the values of the individual option names given in the PPD file.

The “ModulePool” element is generated by creating a “ModuleCap” child element for each top-level “Module” element created in the first step with the same “ModuleID” attribute and the “Availability” attribute set as necessary (set to “Unavailable” if the availability will be determined later with a digital query or by manual user intervention).

### AuditPool

The AuditPool is an XML data element in a JDF job ticket at the same level as MacroPool, ResourcePool and ResourceLinkPool. It is used to record production data such as the date and time the job ticket was created, modified and executed. Although it does not contain any elements mapped from the PPD file, a template for the AuditPool is included in the mapping file in the same manner as the device-independent macros of the MacroPool (i.e. as a sibling of ResourcePool, ResourceLinkPool and ProcessPool).

### Device Capability Generator

The above sections describe all the functions necessary to generate a device capability file. To create a device capability file, the methods start with an XML root of “/DeviceInfo/Device/DeviceCap”, then add the DevCaps elements for the ResourcePool and ResourceLinkPool as children of DeviceCap, and add the elements MacroPool, TestPool, ModulePool and AuditPool as children of Device (and siblings of DeviceCap).

### Ticket Generator

A device capability file may be prepared to serve as a template for job ticket generation by loading the device capability XML into memory and then using either Macros or direct editing to set “CurrentValue” attributes as desired for device capability elements that model elements in a job ticket. Device capability elements with the “Context” attribute set to “Element” will result in job ticket elements that are direct children of the “JDF” root element. Device capability elements with the “Context” attribute set to “Resource” generate child elements of the ResourcePool in the job ticket and those with “Context” set to “Link” generate children of the ResourceLinkPool in the job ticket.

An exemplary algorithm for generation of a job ticket based on the generated device capability file is as follows:

| | |
|---|---|
| 1. | For each “DevCaps” child of the “DeviceCap” element in the device |
| | capability file: |

| | |
|---|---|
| a. | If the “Context” attribute is “Element” move to the node “/JDF” |
| | in the output job ticket; else, if it's “Resource”, move to the |
| | node “/JDF/ResourcePool” in the output; else, if it's “Link”, |
| | move to the node “/JDF/ResourceLinkPool” |
| b. | Get the “DevCap” child of the “DevCaps” element, call a |
| | recursive function which does the following: |

| | |
|---|---|
| i. | Start a new element in the output job ticket with name equal |
| | to the value of the “Name” attribute of the “DevCap” |
| | element |
| ii. | For each child element of the“DevCap” element: |

| | |
|---|---|
| 1. | If it is another “DevCap” element, recurse |
| 2. | Otherwise, if it is a StringState, EnumerationState, |
| | IntegerState, DateTimeState or XYPairState: |

| | |
|---|---|
| a. | Start an attribute of the current element in the |
| | output job ticket having the name of the state |
| | element in the device capability description |
| b. | Set the value of the attribute in the job ticket to |
| | the value of the “CurrentValue” attribute of |
| | the state element; else |

| | |
|---|---|
| i. | If there is no “CurrentValue” attribute in the |
| | state element, use the “DefaultValue” |
| | attribute; else |

| | |
|---|---|
| 1. | If there is no “DefaultValue” |
| | attribute in the state element, use the |
| | first value found in the |
| | “AllowedValueList” attribute in the |
| | state element; else |

| | |
|---|---|
| a. | If no value can be |
| | determined, raise an error |

| | |
|---|---|
| c. | End the attribute in the output job ticket |

| | |
|---|---|
| iii. | End the element in the output job ticket started in 1.b.i |

| | |
|---|---|
| 2. | End the job ticket |

### Ticket Validation

There are different phases of the print job production process in which a job ticket may be validated and different levels of validation, which may be checked. Production phases include job ticket creation, job queue submission, and job execution. Print job ticket validation at ticket-creation time would likely be performed by the host-based client application while execution-time validation may be performed by the host client. This validation at the time of print job ticket creation may use the TestPool and ModulePool features of the generated device capability file as discussed above. The validation at the time of job ticket creation may validate that the generated job ticket represents a valid print job ticket for a print job that may be executed by the identified printing device. In other words, the identified printing system has capabilities, whether presently configured or not, to execute the features in the created print job ticket.

Further, for any of several reasons, the host system may generate a print job ticket for a job to be printed later. For example, a generated print job ticket may be entered into a queue (e.g., a spool) to be de-queued (de-spooled) for transmission to the printing system at some later time. Or, for example, a user may create the print job ticket indicating that it is to be sent to the printing system at, or after, some designated time. Or, by way of further example, a print shop operator may hold execution of print jobs that all require some common finisher component configuration so that all such jobs may be “batched” for a later time at which the operator intends to re-configure the printing system to incorporate the particular finishing options. In such cases, the client software (e.g., print queue/spool management modules) may validate the generated job ticket a second time after its creation. The second validation of the generated job ticket may be performed just before the job, represented by the generated job ticket, is sent to the printing system for execution of the print job. In this second job ticket validation, the validation process may query the printing system to determine the present configuration of the printing system. Thus, the second validation of the generated job ticket validates that the printing system is presently configured to allow execution of the print job represented by the generated job ticket.

Yet another opportunity exists for the job ticket to be validated within the printing system. Since the printing system receives and processes the job ticket, the job ticket may be validated a third time in conjunction with it receive and/or execution within the printing system. In this third possible validation, the device PostScript file may be used to validate the JDF features specified in the job ticket are appropriate for the present configuration of the printing system in its present operational state. Constraint information may also be encoded within the device PostScript file to validate that combinations of features are capable of being executed by the printing system in its present configuration and in its present operational state.

Thus, the various levels of job ticket validation may include all possible configurations of the printing device supported by the manufacturer, or may include only the subset of configurations possible with the particular set of optional accessories and paper types available on-site, or may include only the current device configuration of he printing device as presently configured and as present operational.

Job ticket validation against the current device configuration can be performed by the host-based client application as follows:

| | |
|---|---|
| 1. | Send the device query strings for installable options (i.e., as defined |
| | in the ModulePool of the DevCaps file generated from the PPD file) |
| | to the printer, taking care to record the responses as the values for |
| | the names of the installable options so that they may be referred to |
| | by constraint statements (e.g., assure return is recorded as expected |
| | “none”, “yes”, “no”, “true”, “false”, etc.) |
| 2. | Process all “Test” elements in the TestPool which have names |
| | ending in “_Exclusions”. If any test returns a value |
| | of true, it means a conflict has been found |
| 3. | If a conflict was found, pass a description of the conflict to the |
| | caller so that it can be resolved |
| 4. | If no conflict was found, return a result to the caller indicating the |
| | ticket is valid |

To check for a wider range of configurations than just the current configuration, step 1 of the above algorithm may be modified to allow constraints to be checked against more than one of the possible query responses listed in the DevCaps file, instead of just the single response obtained by sending the query to the device at the current time.

Job ticket validation performed on the device by the printer-resident JDF interpreter is described in the next section as an aspect of the device PostScript file.

### Device PostScript File

Printer-based processing of job tickets generated from a device capability file that was, in turn, derived from a PPD file and a mapping file, requires agreement between the ticket processor and the device capability generator about how JDF elements and attributes map to the device features specified in the PPD file. This is most easily accomplished by using the PPD and mapping file to generate a device PostScript table that contains all the information necessary for the ticket processor (i.e., the printing system) to unambiguously determine the appropriate device command sequences for any job ticket that was generated for the device described by the same PPD. Other information from the PPD may also be written to the device PostScript file including, for example: device command ordering and feature setting constraints. This is called a “device PostScript table” (or equivalently a “device PostScript file”).

Print production functions necessary to process a job ticket on a PostScript device may fall into two categories: those that are implemented by device commands (such as the command to set duplex), and those that are implemented by device-independent PostScript commands such as the PostScript rotate command. Device commands are specified by the PPD file. Device-independent PostScript commands can be specified in a general form in the mapping file.

Each device command specified in a PPD file is accompanied by an “OrderDependency” statement which indicates (by means of an integer) when a command should be executed relative to other commands. This is useful because some device commands can invalidate earlier commands by setting the parameters they control back to their default values. For example, setting a new page size may reset the duplex mode to simplex (i.e., duplex off). In such a case, it would be useful to execute the page size setting command before the duplex setting command. In the PPD file for such a device, the order value for page size may be a lower number than the order value for duplex, indicating that page size should be set before duplex (or, conversely, higher numbered commands could be executed before lower numbered commands). The device-independent commands can also be assigned order values so that they too, can be executed in a specific order. Command order values are copied to the device PostScript table, from which they can be used by the job ticket processor (i.e., the printing system) after it has converted a partition in the job ticket into a set of device commands to be executed (in proper order) for a section of the output document. The command order information for device commands can be copied directly from the PPD to the device PostScript table. The command order information for device-independent PostScript commands may be supplied by the mapping file.

Constraint information in the PPD (e.g., constraint information that indicates which feature setting pairs are mutually incompatible) cannot be copied directly to the device PostScript file for use in job ticket validation because they reference PPD names rather than the JDF names used in a job ticket. The mapping file must be used to map the PPD names to JDF names in such a way that the resulting data structure in the device PostScript file representing the constraints can be used by a job ticket processor to validate the job ticket. Further information regarding the structure and use of constraint and other information in the device PostScript file to validate JDF job tickets is presented below.

JDF processes don't always have the same name as the resources they require (e.g., the process ColorSpaceConversion uses the resource ColorantControl). Since a ticket processor should be aware of partitioned resources (which represent different parts of the output document), it is also helpful to have an indication of the name of the partitionable resource. In a JDF job ticket the partitionable resource may have the same name as the resource itself. This resource/partition name may be supplied by the mapping file and copied into the device PostScript file for use by the ticket processor. The ticket processor then interprets the various partitions in a JDF resource as indicating the device settings for the various sections in the output.

### Device PostScript Based on ProcessPool

The ProcessPool element in the mapping file provides an appropriate structure for the construction of the device PostScript file because the JDF standard describes a print job as a series of processes to be executed by the ticket processor. The list of processes for a specific job may be supplied in the job ticket as the string value of the “Types” attribute of the top-level “JDF” node. A device PostScript table useful to the ticket processor may comprise a PostScript dictionary with an entry for every name that might appear in the process list as determined by the combination of the PPD and mapping files (all processes may not be available on all devices, e.g., stitching). The value of each process entry may comprise information necessary to execute that process. This information may comprise pathnames to specific attributes in the JDF job ticket, sub-dictionaries that associate specific values for each attribute to device commands and device-independent procedures, and command ordering information and the name of potential partitions, which indicate how to divide the output document into different sections with different settings. Also, the attribute pathname information may support some convention for resource references that occur in JDF job tickets, such as the “rRef” attribute of the “MediaRef” element that is a child of the “DigitalPrintingParams” element.

Such a process dictionary may be used by the ticket processor as it iterates through the list of processes in the “Types” attribute of the top-level “JDF” node of the job ticket. The name of each process listed may be looked up in the process dictionary; the value of the located entry may be a sub-dictionary containing the information necessary to drive that process. This sub-dictionary information may include a key such as “PartitionName” with a string value containing the name of the partitionable resource for this process and one or more further sub-dictionaries, each of which describing a mapping from one or more JDF attributes to a “command array” containing a device command, device-independent PostScript procedure, or a combination of both, plus a command order number. The mapping can be described by a hierarchical tree structure with a node depth equal to twice the number of JDF attributes that are mapped to a single command array: one node containing the pathname of each attribute and a sub-level of child nodes for allowed values of the attribute. If the JDF attribute is the last one being mapped, its child nodes will each have a child node containing the appropriate command array. By selecting the attribute child node with the value that the attribute may be set to in the actual job ticket, the ticket processor can identify the commands to be processed. If the JDF attribute is not the last one being mapped, its child nodes will each have a child node containing the next attribute to be mapped. In many cases there will only be one attribute mapped, such as the collate feature, as shown in the following simplified, exemplary device PostScript table entry:

```
/JDFProcessDict <<
    /DigitalPrinting <<
        /PartitionName /DigitalPrintingParams
        /JDF.ResourcePool.DigitalPrintingParams.Collate <<
            /None [200 {<</Collate false>>setpagedevice}]
            /Sheet[200 {<</Collate true /CollateDetails
                    <</Type 6 /AlignSet false>> >>setpagedevice}]
        >>
    >>
>>
```

The ticket processor may use the above example in accordance with the following algorithm:

| | |
|---|---|
| 1. | If the job ticket specifies the DigitalPrinting process |

| | |
|---|---|
| a. | Navigate to /JDF/ResourcePool/DigitalPrintingParams |
| b. | Find the DigitalPrintingParams partition matching the current |
| | page or sheet |
| c. | Load value of “Collate” attribute from matched |
| | DigitalPrintingParams node |
| d. | If “None”, then |

| | |
|---|---|
| i. | After executing all commands with order number less |
| | than 200 |
| ii. | Before executing any commands with order number over |
| | 200 |
| iii. | Execute the procedure {<</Collate false>>setpagedevice} |

| | |
|---|---|
| e. | If “Sheet”, then |

| | |
|---|---|
| i. | After executing all commands with order number less |
| | than 200 |
| ii. | Before executing any commands with order number over |
| | 200 |
| iii. | Execute the procedure {<</Collate true /CollateDetails |

<</Type 6 /AlignSet false>>
>>setpagedevice}

Such a process dictionary makes it relatively easy to implement a ticket processor. When completed with all features for all processes, the dictionary contains all the JDF and PPD information necessary to interpret and execute a job ticket on a particular device.

This process dictionary may be part of a device PostScript file that also comprises device-independent procedure definitions for tasks such as page layout and XML parsing. This process dictionary can be generated directly from just the PPD and mapping file. The attribute pathnames and allowed values in the process dictionary will match the pathnames and allowed values in the device capability file that is generated from the same PPD and mapping file. These pathnames and allowed values are referenced in the device capability file by both DevCaps elements and macros in the MacroPool. The mapping file thus supports the automated generation of a complete JDF workflow system on any printing device for which a PPD file exists.

The information generated from the PPD and mapping file may also support job partitions, resource references, multiple manufacturers, and customizable functionality. The exemplary mapping file excerpt below describes a single process and the resource it requires:

```
<JDF>
    <ProcessPool>
        <ColorSpaceConversion>
            <Partition Name=“ColorantControl”/>
            <PPDFeature Name=“ColorModel” OEM=“OEM1”/>
            <PPDFeature Name=“EFColorMode” OEM=“OEM2”/>
        </ColorSpaceConversion>
    </ProcessPool>
    <ResourcePool>
        <ColorantControl>
            <ProcessColorModel>
                <PPDFeature Name=“ColorModel” OEM=“OEM1”>
                    <Setting PPD=“CMYK” JDF=“DeviceCMYK”/>
                    <Setting PPD=“Gray” JDF=“DeviceGray”/>
                </PPDFeature>
                <PPDFeature Name=“EFColorMode”
                OEM=“OEM2”>
                    <Setting PPD=“CMYK” JDF=“DeviceCMYK”/>
                    <Setting PPD=“Grayscale” JDF=“DeviceGray”/>
                </PPDFeature>
            </ProcessColorModel>
        </ColorantControl>
    </ResourcePool>
</JDF>
```

The following example is a PostScript dictionary tree structure in a device PostScript table generated from the combination of a mapping file and a PPD file for an “OEM1” printer. This PostScript dictionary is designed to support a process-based interpretation of the job ticket, where the processes listed in the “Types” attribute of the top-level “JDF” node are iterated in order and the resources needed by each process are specified by the PostScript dictionary. The single process described in this example is ColorSpaceConversion, the same as in the mapping file example above. Note that the two leaves of the tree structure are key/value pairs where the key is the name of the JDF setting and the value is an array containing the order number and a procedure containing the relevant device command.

```
/JDFProcessDict <<
    /ColorSpaceConversion<<
        /PartitionName /ColorantControl
        /JDF.ResourcePool.ColorantControl.ProcessColorModel <<
            /DeviceCMYK[100 {(cmyk) RCsetdevicecolor}]
            /DeviceGray[100 {(gray) RCsetdevicecolor}]
        >>
    >>
>>
```

The PostScript dictionary tree structure becomes more complex when a PPD command is mapped to multiple locations in a JDF job ticket. The following exemplary dictionary entry for the Stitching process shows how ten different variants of the device command for stapling are each mapped to a unique combination of four different JDF attribute values (three in ResourcePool, one in ResourceLinkPool):

```
/Stitching<<
  /PartitionName /StitchingParams
  /JDF.ResourcePool.StitchingParams.StitchType <<
      /Corner <<
        /JDF.ResourcePool.StitchingParams.Angle <<
          /0 <<
            /JDF.ResourcePool.StitchingParams.NumberOfStitches <<
              /1 <<
                /JDF.ResourceLinkPool.ComponentLink.Orientation <<
                  /Rotate0 [50 {15 XJXsetstapleV2}]
                  /Rotate90 [50 {17 XJXsetstapleV2}]
                >>
              >>
            >>
          >>
          /45 <<
            /JDF.ResourcePool.StitchingParams.NumberOfStitches <<
              /1 <<
                /JDF.ResourceLinkPool.ComponentLink.Orientation <<
                  /Rotate0 [50 {1 XJXsetstapleV2}]
                  /Rotate90 [50 {2 XJXsetstapleV2}]
                >>
              >>
            >>
          >>
          /90 <<
            /JDF.ResourcePool.StitchingParams.NumberOfStitches <<
              /1 <<
                /JDF.ResourceLinkPool.ComponentLink.Orientation <<
                  /Rotate0 [50 {6 XJXsetstapleV2}]
                  /Rotate90 [50 {7 XJXsetstapleV2}]
                >>
              >>
            >>
          >>
        >>
      >>
      /Side <<
        /JDF.ResourcePool.StitchingParams.Angle <<
          /0 <<
            /JDF.ResourcePool.StitchingParams.NumberOfStitches <<
              /2 <<
                /JDF.ResourceLinkPool.ComponentLink.Orientation <<
                  /Rotate90 [50 {5 XJXsetstapleV2}]
                >>
              >>
            >>
          >>
          /90 <<
            /JDF.ResourcePool.StitchingParams.NumberOfStitches <<
              /2 <<
                /JDF.ResourceLinkPool.ComponentLink.Orientation <<
                  /Rotate0 [50 {3 XJXsetstapleV2}]
                  /Rotate180 [50 {4 XJXsetstapleV2}]
                >>
              >>
            >>
          >>
        >>
      >>
      /Saddle <<
        /JDF.ResourcePool.StitchingParams.Angle <<
          /0 <<
          /JDF.ResourcePool.StitchingParams.NumberOfStitches <<
              /2 <<
                /JDF.ResourceLinkPool.ComponentLink.Orientation <<
                  /Rotate90 [50 {10 XJXsetstapleV2}]
                >>
            >>
          >>
        >>
      >>
    >>
  >>
>>
```

The device PostScript in the preceding example may be used by a printing system ticket processor to establish the device staple setting from the job ticket in accordance with the following exemplary algorithm:

| | |
|---|---|
| 1. | Determine the “StitchingParams” partition in the job ticket that |
| | applies to the current section of the document being output |
| 2. | In this partition, get the value of the attribute |
| | /JDF/ResourcePool/StitchingParams/StitchType |
| 3. | Use the value of this attribute (Corner, Side or Saddle) to navigate |
| | one level lower in the mapping file structure |
| 4. | Get the value of the attribute /JDF/ResourcePool/StitchingParams/ |
| | Angle from the job ticket |
| 5. | Use the value of this attribute (0, 45 or 90) to navigate one level |
| | lower in the mapping file |
| 6. | Get the value of the attribute /JDF/ResourcePool/StitchingParams/ |
| | NumberOfStitches |
| 7. | Use the value of this attribute (1 or 2) to navigate one level lower |
| | in the mapping file |
| 8. | Get the value of the attribute /JDF/ResourceLinkPool/ |
| | ComponentLink/Orientation |
| 9. | Use the value of this attribute (Rotate0, Rotate90, Rotate180) |
| | to select an array, then |

| | |
|---|---|
| a. | After executing all commands with order number less than 50 |
| b. | Before executing any commands with order number over 50 |
| c. | Execute the procedure contained in the array |

Thus, the device PostScript table specifies the mapping from attribute values in the job ticket to both device-dependent commands and device-independent procedures to be executed for each process in the print job.

All of PostScript code in the above examples can be generated from the PPD file and the mapping file using the following exemplary algorithm:

| | |
|---|---|
| 1. | Start a new PostScript dictionary “JDFProcessDict” in a new output file |
| 2. | For each process in the ProcessPool of the mapping file: |

| | |
|---|---|
| a. | Start a new dictionary in the output with the same name as the process |
| b. | Output a key “PartitionName” with value of the “Name” attribute of the |
| | “Partition” child element of the process element in the ProcessPool |
| c. | Call a recursive function to collect the values of all the “Path” attributes of all |
| | “JDFFeature” elements that are descendants of the process element |
| d. | For each “Path” attribute value collected: |

| | |
|---|---|
| i. | Convert the path value to a PostScript name and output it as the name |
| | of a new dictionary started in the output |

| | |
|---|---|
| 1. | If the path does not contain the partition name, it must be |
| | referenced from the partition, so before converting to a |
| | PostScript name, insert the partition name plus “/” before the |
| | top resource name in the path and add “Ref/rRef” to the end of |
| | the top resource name in the path. |

| | |
|---|---|
| ii. | Navigate to the location of the path in the mapping file and find the |
| | “JDFFeature” element there, for each “Setting” child of this element: |

| | |
|---|---|
| 1. | Output a PostScript key/value pair with the PostScript key |
| | equal to the value of the “JDF” attribute of the “Setting” |
| | element and the PostScript value equal to the value of the “PS” |
| | attribute of the “Setting” element |

| | |
|---|---|
| iii. | End the PostScript dictionary started in step 2.d.i. |

| | |
|---|---|
| e. | Call a recursive function to collect all the “PPDFeature” elements that are |
| | descendants of the process element in the mapping file and which have |
| | “OEM” attributes equal to the name of the manufacturer of the device |
| | describedby the PPD file |
| f. | For each “PPDFeature” descendant of the process element collected: |

| | |
|---|---|
| i. | Call a recursive function to find all “PPDFeature” elements with the |
| | same “Name” and “OEM” attributes in the ResourcePool and |
| | ResourceLinkPool of the mapping file and collect the XML paths of |
| | these PPDFeature elements |
| ii. | Call another recursive function with six parameters: the name of the |
| | PPD feature, the list of XML paths collected in the previous step, the |
| | number of paths in the list, the mapping file node that corresponds to |
| | the first path in the list, an integer indicating the current recursion level |
| | initialized to zero, and a list of PPD options initialized to an empty list. |
| | For each recursion of this function: |

| | |
|---|---|
| 1. | Collect all the options for this feature listed in the PPD file |
| 2. | Get the OrderDependency number for this feature from the |
| | PPD |
| 3. | If the PPDFeature found does not have any “Setting” child |
| | elements: |

| | |
|---|---|
| a. | Start a new PS dictionary in the output with a name |
| | equal to the XML pathname (slashes may need to be |
| | replaced by another character for the sake of PS syntax) |
| b. | For all options listed in the PPD file for this feature: |

| | |
|---|---|
| i. | Start a key/value pair in the output with the |
| | option name as the key and start an array as the |
| | value in the output |
| ii. | Output the OrderDependency number as the first |
| | element of the array |
| iii. | Get the PS code from the invocation value, wrap |
| | it in curly braces (making it a PS procedure) and |
| | output it as the second element of the array. |
| iv. | End the array. |

| | |
|---|---|
| c. | End the PS dictionary started in step 2.f.ii.1 |

| | |
|---|---|
| 4. | Else, if the “PPDFeature” has “Setting” child elements |

| | |
|---|---|
| a. | For each “Setting” element: |

| | |
|---|---|
| i. | Start a new list |
| ii. | Get the list of option names from the “PPD” |
| | attribute of the “Setting” element |
| iii. | For each option name found, if the current |
| | recursion level parameter is zero or if the option |
| | name occurs in the list of PPD options |
| | parameter, add it to the new list |
| iv. | If the new list is not empty: |

| | |
|---|---|
| 1. | If this is the first “Setting” element being |
| | iterated in step 2.f.ii.4, start a new |
| | dictionary in the output with a name |
| | formed from the XML pathname in the |
| | XML paths parameter indexed by the |
| | current recursion level number |

| | |
|---|---|
| a. | If the path does not contain the |
| | partition name, it must be |
| | referenced from the partition, so |
| | before converting to a PostScript |
| | name, insert the partition name |
| | plus “/” before the top resource |
| | name in the path and add |
| | “Ref/rRef” to the end of the top |
| | resource name in the path. |

| | |
|---|---|
| 2. | If the current recursion level is less than |
| | one less than the number of paths in the |
| | XML paths parameter |

| | |
|---|---|
| a. | Start a new dictionary in the |
| | output with a name formed from |
| | the value of the “JDF” attribute of |
| | the “Setting” element |
| b. | If the new list started in step |
| | 2.f.ii.4.a.i is not empty: |

| | |
|---|---|
| i. | Make a recursive call to |
| | the function in step 2.f.ii |
| | with the six parameters: |
| | the name of the PPD |
| | feature, the list of XML |
| | paths, the number of paths |
| | in the list, the mapping |
| | file node that corresponds |
| | to the path indexed by the |
| | current recursion level in |
| | the list, an integer |
| | indicating the current |
| | recursion level, and the |
| | new list started in step |
| | 2.f.ii.4.a.i. |

| | |
|---|---|
| c. | End the dictionary |

| | |
|---|---|
| 3. | Else the last recursion level has been |
| | reached, if the new list started in step |
| | 2.f.ii.4.a.i is not empty, then |

| | |
|---|---|
| a. | If the list has more than one |
| | name, raise an error condition |
| | and exit the function |
| b. | Else, search the feature in the |
| | PPD file for the option name in |
| | the list |

| | |
|---|---|
| i. | Output a key/value pair |
| | with the value of the |
| | “JDF” attribute of the |
| | “Setting” element as the |
| | key and start an array in |
| | the output as the value |
| ii. | Output the |
| | OrderDependency |
| | number as the first item in |
| | the array |
| iii. | Output a “{” starting a |
| | new procedure in the |
| | output |
| iv. | Output the PS code from |
| | the invocation value of |
| | the option in the PPD |
| | identified in step |
| | 2.f.ii.4.a.iv.3.b |
| v. | If the “Setting” element |
| | has a “PS” attribute, |
| | output the PS code |
| | contained in its value |
| vi. | Output a “}]” ending the |
| | procedure and array |

| | |
|---|---|
| 4. | End the dictionary started in step |
| | 2.f.ii.4.a.iv.1. |

| | |
|---|---|
| g. | End the dictionary started in step 2.a |

| | |
|---|---|
| 3. | End the dictionary started in step 1. |

### Constraints, Installable Options, and Printer-Based Job Ticket Validation

The printer-based JDF interpreter is the last line of defense against errors in the job ticket caused by mutually incompatible feature settings and required hardware options that have not been installed. The text lines beginning with “*UIConstraints” in the PPD file list pairs of incompatible feature settings, some of which may reference optional hardware listed under “OpenGroup: Installable Options”.

The data structures in the device PostScript file representing PPD constraint data must account for the fact that multiple JDF features may be mapped to a single PPD feature named in a constraint. One exemplary embodiment provides two PostScript dictionaries, a first dictionary that allows a PPD feature setting to be associated with one or more JDF feature settings and a second dictionary that allows a PPD feature setting to be associated with one or more other PPD feature settings that are incompatible with it. The mapping file must be used to generate the first dictionary. The second dictionary may be generated directly from the PPD file. A third PostScript dictionary, representing the installable options, may also be generated directly from the PPD file.

The following is an example of three dictionaries to be generated in a device PostScript file using the technique of joining feature and setting names with an underscore to form single names:

```
/OEM1ConstraintNames <<
  /InputSlot_MultiTray <<
    /JDF.ResourcePool.Media.Location.LocationName (BypassTray)
  >>
  /OutputBin_Standard <<
    /JDF.ResourcePool.DigitalPrintingParams.OutputBin (Tray)
  >>
  /StapleLocation_UpperLeft <<
    /JDF.ResourcePool.StitchingParams.StitchType (Corner)
    /JDF.ResourcePool.StitchingParams.Angle (90)
    /JDF.ResourcePool.StitchingParams.NumberOfStitches (1)
    /JDF.ResourceLinkPool.ComponentLink.Orientation (Rotate0)
  >>
  >>
  /OEM1Installables <<
    /Finisher {accessorydict /currentattachment get
      dup 0 eq{pop(None)}
        {dup 1 eq{pop(Staple)}
          {2 eq{(StapleAndPunch)}
            {(None)}ifelse}ifelse}ifelse
    }
  >>
  /OEM1Constraints <<
    /InputSlot_MultiTray [/StapleLocation_UpperLeft]
    /OutputBin_Standard [/StapleLocation_UpperLeft]
    /Finisher_None [/StapleLocation_UpperLeft]
          /StapleLocation_UpperLeft [/InputSlot_MultiTray
  /OutputBin_Standard /Finisher_None]
  >>
```

In the above example, three PPD feature setting name pairs are provided. The feature-setting name are defined in terms of JDF feature setting names in the dictionary “OEM1ConstraintNames” and a device query for “Finisher” defined in the dictionary “OEM1Installables”. The dictionary “OEM1Constraints” then refers to these feature setting name pairs, the device query and a possible query response in the definitions of four constraints.

A ticket processor implemented in PostScript would use this information in the device PostScript file to validate a job ticket in accord with the following algorithm:

| | |
|---|---|
| 1. | For each key value pair in the dictionary OEM1Constraints |

| | |
|---|---|
| a. | If the key exists in the dictionary OEM1ConstraintNames, get |
| | the dictionary and |

| | |
|---|---|
| i. | For each key value pair in the dictionary, look up the JDF |
| | job ticket location identified by the key and check if it has |
| | the setting identified by the value; if all of the JDF |
| | locations have the indicated settings, the constraint must |
| | be checked. Else, if any of the JDF locations listed in the |
| | dictionary do not have the indicated setting, the constraint |
| | does not need to be checked |

| | |
|---|---|
| b. | Else, if the first part of the key (before the underscore) exists |
| | in the dictionary OEM1Installables, get the PostScript |
| | procedure which is the value and |

| | |
|---|---|
| i. | Execute it, if the resulting name string on the stack is the |
| | same as the name following the underscore in the |
| | key, the constraint must be checked; otherwise, the |
| | constraint does not need to be checked. |

| | |
|---|---|
| 2. | If the test in step 1 determines that the constraint must be checked, |
| | then get the array of names which is the value associated with the |
| | key in the OEM1Constraints dictionary and for each name in the |
| | array: |

| | |
|---|---|
| a. | Look up the name in either OEM1ConstraintNames or |
| | OEM1Installables as in step 1, if a setting match is found by |
| | step 1a or 1b, a conflict has been identified and the job ticket |
| | is not valid; stop the iterative evaluation process and return an |
| | error with both the key in OEM1Constraints that was |
| | being iterated and the name in the array that identified a conflict |
| b. | Else, if none of the names in the array evaluated in the previous |
| | step result in a feature setting that matches one of the job ticket's |
| | feature settings, the constraint has not been violated and no |
| | conflict has been identified, so continue iterating the key value |
| | pairs in the dictionary OEM1Constraints |

The PostScript dictionary OEM1Installables described above can be generated directly from the PPD file without using the mapping file, as follows:

| | |
|---|---|
| 1. | Start a new PostScript dictionary named “OEM1Installables” in the |
| | output device PostScript file |
| 2. | For each “*OpenUI” statement between the “*OpenGroup: |
| | InstallableOptions” and “*CloseGroup: InstallableOptions” |
| | statements in the PPD file: |

| | |
|---|---|
| a. | If there is a query, which is a statement beginning with “*?”, |
| | between the “*OpenUI” and “*CloseUI” statements, add |
| | a key value pair to the OEM1Installables dictionary where |
| | the key is the name following the “*OpenUI” keyword |
| | with the leading asterisk removed and the value is a |
| | PostScript procedure containing the quoted string of PostScript |
| | query code that follows the sequence of the string “*?” |
| | plus the keyword plus the colon character |

| | |
|---|---|
| 3. | End the dictionary started in step 1. |

The two PostScript dictionaries OEM1ConstraintNames and OEM1Constraints have structure and content similar to the two-part TestPool data structure in the DevCaps file and can be generated from the PPD and mapping files in a similar manner:

| | |
|---|---|
| 1. | Start a new dictionary named “OEM1ConstraintNames” in the output device |
| | PostScript file |
| 2. | For each unique feature/option pair in each “UIConstraint” statement in the PPD |
| | file: |

| | |
|---|---|
| a. | Call a recursive function to count how many PPDFeature elements in the |
| | ResourcePool and ResourceLinkPool of the mapping file have the feature |
| | name as the value of the “Name” attribute and the option name contained |
| | in the PPD attribute of any of the “Setting” children of the PPDFeature |
| | element. |
| b. | If the count of PPDFeatures is greater than zero, start a new key-value pair |
| | in the output dictionary OEM1ConstraintNames with the feature and |
| | setting names joined by an underscore character as the key and start a new |
| | sub-dictionary as the value (i.e. key-value pairs for unmapped features will |
| | not be output) |
| c. | Call a recursive function similar to the one used to count relevant |
| | PPDFeature elements in step 2.a., but this time, for each PPDFeature |
| | element's “Name” attribute and “Setting” child element's “PPD” attribute |
| | that contain a match for the feature/option pair being searched, output a |
| | key-value pair in the current sub-dictionary with the key formed from the |
| | pathname of the location of the PPDFeature in the mapping file and the |
| | value being the a string with the same content as the value of the “JDF” |
| | attribute of the “Setting” element |
| d. | End the sub-dictionary started in step 2b. |

| | |
|---|---|
| 3. | End the dictionary “OEM1ConstraintNames” started in step 1. |
| 4. | Start a new dictionary named “OEM1Constraints” in the output device PostScript |
| | file |
| 5. | For each unique feature/option pair in each “UIConstraint” statement in the PPD |
| | file for which either a key-value pair was output in step 2 or for which a key-value |
| | pair exists in the OEM1Installables dictionary with a key equal to the feature |
| | name : |

| | |
|---|---|
| a. | Start a new key-value pair in the output OEM1Constraints dictionary with |
| | the feature and setting names joined by an underscore character as the key |
| | and start a new array as the value |
| b. | Build a list of all other UIConstraint statements which prohibit this |
| | feature/option pair |
| c. | Create a name for each statement in the list by joining the prohibiting |
| | feature and setting names with an underscore |
| d. | For each name formed from the list, check if it exists in the |
| | OEM1ConstraintNames dictionary or if the first part of the name (the |
| | prohibiting feature name) exists in the OEM1Installables dictionary |
| e. | If either existence check in step 5d results in “true”, then add the formed |
| | compound name to the output array |
| f. | End the array started in step 5a. |

| | |
|---|---|
| 6. | End the OEM1Constraints dictionary started in step 4. |

An example of a complete mapping file that supports three values for OEM (“OEM1”, “OEM2”, and “OEM3”) is attached as an external Appendix A.

FIG. 8 is a flowchart describing another exemplary method in accordance with features and aspects hereof to generate and utilize a device capability file and a device PostScript table. Steps 800 through 816 may be operable on a computing system such as discussed with respect to FIGS. 1 and 2 to generate a device capability file from the provided PPD and mapping files. Step 800 first converts the provided PPD file into an XML format tree structure for simpler parsing and processing. As discussed above, the mapping file preferably is already specified in XML format and thus may also be read into an XML tree data structure for simpler processing. Step 802 then determines the OEM identifier to select among various options in the mapping file. The OEM may be designated in the provided PPD file or may be entered manually by an administrative user. Step 804 then starts a new device capability output file. Step 806 converts the AuditPool information in the mapping file into corresponding DevCaps format and adds the converted information to the newly started device capability output file. Steps 808 and 810 generate corresponding DevCaps entries from the ResourcePool and ResourceLinkPool, respectively, information in the mapping file in conjunction with the PPD file information (as converted to XML format). Step 812 generates the constraint information in the device capability file based on the TestPool information in the mapping file in conjunction with the PPD file information. Step 814 generates MacroPool information into the device capability file in accordance with the mapping file and PPD file information. Step 816 generates ModulePool information into the device capability file based on the mapping file information and the PPD file information regarding installable options of the printing system.

Steps 818 through 822 are operable in the computing system (e.g., of FIGS. 1 and 2) to generate the device PostScript table based on information in the mapping file and the PPD file. Step 818 creates a new output file to contain the generate device PostScript table information. As noted, the device PostScript table may be encoded as a PostScript dictionary structure or other suitable data structures to be transmitted to and processed by the printing system. Thus, the file generated by the computing system will contain the device PostScript file to be sent to the printing system. Step 820 starts a new PostScript dictionary structure for each element in the ProcessPool of the mapping file. Step 822 then adds a dictionary tree for each PPD feature or JDF feature mapped by the ProcessPool entries of the mapping file. The file comprising the completed device PostScript table is then transmitted to the printing system for storage and utilization therein.

Step 824 then modifies the generated device capability file in accordance with macro choices submitted by a user to manually select choices for proper operation of a particular printing system.

Steps 826 through 832 then represent processing to create a print job based on the generated device capability file to be executed by the printing system in accordance with the generated device PostScript table. Step 826 generates a JDF job ticket from user supplied options based on the generated device capability file. Step 828 then combines the generated job ticket with any required content (print data) files and step 830 transmits the combined job ticket and print job data (content files) to the printing system.

Step 832 then represents processing in the printing system to process the job based on the partitions and processes selected in the received JDF job ticket and in accordance with the device command strings found in the device PostScript table.

Although specific embodiments were described herein, the scope of the invention is not limited to those specific embodiments. The scope of the invention is defined by the following claims and any equivalents thereof.

### APPENDIX A

An example of a complete mapping file that supports three values for OEM: “OEM1”, “OEM2”, and “OEM3”.

```
<?xml version=“1.0” encoding=“UTF-8”?>
<JDF>
  <ProcessPool>
    <Interpreting>
      <Partition Name=“InterpretingParams”/>
    </Interpreting>
    <Rendering>
      <Partition Name=“RenderingParams”/>
    </Rendering>
    <ColorSpaceConversion>
      <Partition Name=“ColorantControl”/>
      <PPDFeature Name=“ColorModel” OEM=“OEM1”/>
      <PPDFeature Name=“EFColorMode” OEM=“OEM2”/>
    </ColorSpaceConversion>
    <LayoutPreparation>
      <Partition Name=“LayoutPreparationParams”/>
      <PPDFeature Name=“Duplex” OEM=“OEM1”/>
      <PPDFeature Name=“EFDuplex” OEM=“OEM2”/>
      <JDFFeature Path=“ResourcePool/LayoutPreparationParams/Rotate”/>
      <JDFFeature Path=“ResourcePool/LayoutPreparationParams/NumberUp”/>
      <JDFFeature Path=“ResourcePool/LayoutPreparationParams/FitPolicy/SizePolicy”/>
      <JDFFeature
Path=“ResourcePool/LayoutPreparationParams/ImageShift/ShiftFront”/>
      <JDFFeature Path=“ResourcePool/LayoutPreparationParams/ImageShift/ShiftBack”/>
    </LayoutPreparation>
    <Imposition>
      <Partition Name=“Layout”/>
    </Imposition>
    <DigitalPrinting>
      <Partition Name=“DigitalPrintingParams”/>
      <PPDFeature Name=“RICollate” OEM=“OEM1”/>
      <PPDFeature Name=“MediaType” OEM=“OEM1”/>
      <PPDFeature Name=“PageSize” OEM=“OEM1”/>
      <PPDFeature Name=“InputSlot” OEM=“OEM1”/>
      <PPDFeature Name=“EFSort” OEM=“OEM2”/>
      <PPDFeature Name=“EFMediaType” OEM=“OEM2”/>
      <PPDFeature Name=“PageSize” OEM=“OEM2”/>
      <PPDFeature Name=“InputSlot” OEM=“OEM2”/>
      <JDFFeature Path=“ResourceLinkPool/ComponentLink/Amount”/>
    </DigitalPrinting>
    <Stitching>
      <Partition Name=“StitchingParams” ResourceLinks=“Component”/>
      <PPDFeature Name=“StapleLocation” OEM=“OEM1”/>
      <PPDFeature Name=“EFStapler” OEM=“OEM2”/>
    </Stitching>
  </ProcessPool>
  <ResourcePool>
    <DigitalPrintingParams>
      <Collate>
        <PPDFeature Name=“RICollate” OEM=“OEM1”>
          <Setting PPD=“False” JDF=“None”/>
          <Setting PPD=“True” JDF=“Sheet”/>
        </PPDFeature>
        <PPDFeature Name=“EFSort” OEM=“OEM2”>
          <Setting PPD=“False” JDF=“None”/>
          <Setting PPD=“Collate” JDF=“Sheet”/>
        </PPDFeature>
      </Collate>
      <MediaRef>
        <rRef>
          <JDFFeature>
            <Setting JDF=“Media0”/>
          </JDFFeature>
        </rRef>
      </MediaRef>
    </DigitalPrintingParams>
    <InterpretingParams>
    </InterpretingParams>
    <RenderingParams>
    </RenderingParams>
    <ColorantControl>
      <ProcessColorModel>
        <PPDFeature Name=“ColorModel” OEM=“OEM1”>
          <Setting PPD=“CMYK” JDF=“DeviceCMYK”/>
          <Setting PPD=“Gray” JDF=“DeviceGray”/>
        </PPDFeature>
        <PPDFeature Name=“EFColorMode” OEM=“OEM2”>
          <Setting PPD=“CMYK” JDF=“DeviceCMYK”/>
          <Setting PPD=“Grayscale” JDF=“DeviceGray”/>
        </PPDFeature>
      </ProcessColorModel>
    </ColorantControl>
    <StitchingParams>
      <StitchType>
        <PPDFeature Name=“StapleLocation” OEM=“OEM1”>
          <Setting PPD=“UpperLeft UpperRight LowerLeft LowerRight” JDF=“Corner”/>
          <Setting PPD=“LeftW RightW UpperW LowerW” JDF=“Side”/>
          <Setting PPD=“CenterW” JDF=“Saddle”/>
        </PPDFeature>
        <PPDFeature Name=“EFStapler” OEM=“OEM2”>
          <Setting PPD=“1UpLeftH 1UpLeftS 1UpLeftV 1UpRightH 1UpRightS 1UpRightV”
JDF=“Corner”/>
          <Setting PPD=“2Left 2Right 2Up” JDF=“Side”/>
          <Setting PPD=“Center” JDF=“Saddle”/>
        </PPDFeature>
        <PPDFeature Name=“StapleLocation” OEM=“OEM3”>
          <Setting PPD=“LeftDiagonal LeftHorizontal LeftVertical RightDiagonal
RightHorizontal
              RightVertical” JDF=“Corner”/>
          <Setting PPD=“DoubleLeft DoubleRight DoubleTop” JDF=“Side”/>
        </PPDFeature>
      </StitchType>
      <Angle>
        <PPDFeature Name=“StapleLocation” OEM=“OEM1”>
          <Setting PPD=“UpperW CenterW LowerW” JDF=“0”/>
          <Setting PPD=“LowerLeft LeftW UpperLeft LowerRight RightW UpperRight”
JDF=“90”/>
        </PPDFeature>
        <PPDFeature Name=“EFStapler” OEM=“OEM2”>
          <Setting PPD=“1UpLeftH 1UpRightH 2Up Center” JDF=“0”/>
          <Setting PPD=“1UpLeftS 1UpRightS” JDF=“45”/>
          <Setting PPD=“1UpLeftV 1UpRightV 2Left 2Right” JDF=“90”/>
        </PPDFeature>
        <PPDFeature Name=“StapleLocation” OEM=“OEM3”>
          <Setting PPD=“LeftHorizontal RightHorizontal DoubleTop” JDF=“0”/>
          <Setting PPD=“LeftDiagonal RightDiagonal” JDF=“45”/>
          <Setting PPD=“LeftVertical DoubleLeft RightVertical DoubleRight” JDF=“90”/>
        </PPDFeature>
      </Angle>
      <NumberOfStitches>
        <PPDFeature Name=“StapleLocation” OEM=“OEM1”>
          <Setting PPD=“LowerLeft LowerRight UpperLeft UpperRight” JDF=“1”/>
          <Setting PPD=“LeftW RightW UpperW LowerW CenterW” JDF=“2”/>
        </PPDFeature>
        <PPDFeature Name=“EFStapler” OEM=“OEM2”>
          <Setting PPD=“1UpLeftH 1UpLeftS 1UpLeftV 1UpRightH 1UpRightS 1UpRightV”
JDF=“1”/>
          <Setting PPD=“2Left 2Right 2Up Center” JDF=“2”/>
        </PPDFeature>
        <PPDFeature Name=“StapleLocation” OEM=“OEM3”>
          <Setting PPD=“LeftHorizontal RightHorizontal LeftVertical RightVertical
LeftDiagonal
              RightDiagonal” JDF=“1”/>
          <Setting PPD=“DoubleLeft DoubleRight DoubleTop” JDF=“2”/>
        </PPDFeature>
      </NumberOfStitches>
    </StitchingParams>
    <Media>
      <MediaTypeDetails>
        <PPDFeature Name=“MediaType” OEM=“OEM1”/>
        <PPDFeature Name=“EFMediaType” OEM=“OEM2”/>
        <PPDFeature Name=“MediaType” OEM=“OEM3”/>
      </MediaTypeDetails>
      <DescriptiveName>
        <PPDFeature Name=“PageSize” OEM=“OEM1”/>
        <PPDFeature Name=“PageSize” OEM=“OEM2”/>
      </DescriptiveName>
      <Location>
        <LocationName>
          <PPDFeature Name=“InputSlot” OEM=“OEM1”>
            <Setting PPD=“MultiTray” JDF=“BypassTray”/>
            <Setting PPD=“1Tray” JDF=“Tray-1”/>
            <Setting PPD=“2Tray” JDF=“Tray-2”/>
            <Setting PPD=“3Tray” JDF=“Tray-3”/>
            <Setting PPD=“4Tray” JDF=“Tray-4”/>
            <Setting PPD=“5Tray” JDF=“Tray-5”/>
            <Setting PPD=“6Tray” JDF=“Tray-6”/>
            <Setting PPD=“7Tray” JDF=“Tray-7”/>
          </PPDFeature>
          <PPDFeature Name=“InputSlot” OEM=“OEM2”>
            <Setting PPD=“AutoSelect” JDF=“AutoSelect”/>
            <Setting PPD=“ManualFeed” JDF=“BypassTray”/>
            <Setting PPD=“Tray1” JDF=“Tray-1”/>
            <Setting PPD=“Tray2” JDF=“Tray-2”/>
            <Setting PPD=“Tray3” JDF=“Tray-3”/>
            <Setting PPD=“Tray4” JDF=“Tray-4”/>
            <Setting PPD=“Tray5” JDF=“Tray-5”/>
            <Setting PPD=“Tray6” JDF=“Tray-6”/>
            <Setting PPD=“Tray7” JDF=“Tray-7”/>
            <Setting PPD=“HighCapacityInputBin1” JDF=“LargeCapacity”/>
            <Setting PPD=“Interposer” JDF=“InsertTray”/>
            <Setting PPD=“InterposerUpper” JDF=“InsertTray-1”/>
            <Setting PPD=“InterposerLower” JDF=“InsertTray-2”/>
            <Setting PPD=“PostFuserTray” JDF=“InsertTray-1”/>
            <Setting PPD=“PostFuserTray2” JDF=“InsertTray-2”/>
          </PPDFeature>
          <PPDFeature Name=“InputSlot” OEM=“OEM3”>
            <Setting PPD=“Tray1” JDF=“Tray-1”/>
            <Setting PPD=“Tray2” JDF=“Tray-2”/>
            <Setting PPD=“Tray3” JDF=“Tray-3”/>
            <Setting PPD=“Tray4” JDF=“Tray-4”/>
            <Setting PPD=“Tray5” JDF=“Tray-5”/>
            <Setting PPD=“Tray6” JDF=“Tray-6”/>
            <Setting PPD=“AuxTray” JDF=“Tray-7”/>
          </PPDFeature>
        </LocationName>
      </Location>
    </Media>
    <LayoutPreparationParams>
      <Sides>
        <PPDFeature Name=“Duplex” OEM=“OEM1”>
          <Setting PPD=“None” PS=“false SetDuplex” JDF=“OneSidedFront”/>
          <Setting PPD=“DuplexNoTumble” PS=“true SetDuplex” JDF=“TwoSidedFlipY”/>
          <Setting PPD=“DuplexTumble” PS=“true SetDuplex” JDF=“TwoSidedFlipX”/>
        </PPDFeature>
        <PPDFeature Name=“EFDuplex” OEM=“OEM2”>
          <Setting PPD=“False” PS=“false SetDuplex” JDF=“OneSidedFront”/>
          <Setting PPD=“TopTop” PS=“true SetDuplex” JDF=“TwoSidedFlipY”/>
          <Setting PPD=“TopBottom” PS=“true SetDuplex” JDF=“TwoSidedFlipX”/>
        </PPDFeature>
        <PPDFeature Name=“Duplex” OEM=“OEM3”>
          <Setting PPD=“None” PS=“false SetDuplex” JDF=“OneSidedFront”/>
          <Setting PPD=“DuplexNoTumble” PS=“true SetDuplex” JDF=“TwoSidedFlipY”/>
          <Setting PPD=“DuplexTumble” PS=“true SetDuplex” JDF=“TwoSidedFlipX”/>
        </PPDFeature>
      </Sides>
      <Rotate>
        <JDFFeature>
          <Setting JDF=“Rotate0” PS=“[1000 {0 SetPageRotate}]”/>
          <Setting JDF=“Rotate90” PS=“[1000 {90 SetPageRotate}]”/>
          <Setting JDF=“Rotate180” PS=“[1000 {180 SetPageRotate}]”/>
          <Setting JDF=“Rotate270” PS=“[1000 {270 SetPageRotate}]”/>
        </JDFFeature>
      </Rotate>
      <NumberUp>
        <JDFFeature>
          <Setting JDF=“XYPAIR” PS=“[1000 {SetNup}]”/>
        </JDFFeature>
      </NumberUp>
      <FitPolicy>
        <SizePolicy>
          <JDFFeature>
            <Setting JDF=“ClipToMaxPage” PS=“[1000 {/Clip SetSizePolicy}]”/>
            <Setting JDF=“FitToPage” PS=“[1000 {/Fit SetSizePolicy}]”/>
            <Setting JDF=“ReduceToFit” PS=“[1000 {/Reduce SetSizePolicy}]”/>
          </JDFFeature>
        </SizePolicy>
      </FitPolicy>
      <ImageShift>
        <ShiftFront>
          <JDFFeature>
            <Setting JDF=“XYPAIR” PS=“[1000 {SetFrontShift}]”/>
          </JDFFeature>
        </ShiftFront>
        <ShiftBack>
          <JDFFeature>
            <Setting JDF=“XYPAIR” PS=“[1000 {SetBackShift}]”/>
          </JDFFeature>
        </ShiftBack>
      </ImageShift>
    </LayoutPreparationParams>
    <LayoutElement>
      <FileSpec>
        <URL>
          <JDFFeature>
            <Setting JDF=“STRING” PS=“[1000 {SetInputFile}]”/>
          </JDFFeature>
        </URL>
      </FileSpec>
    </LayoutElement>
    <RunList>
      <LayoutElementRef>
        <rRef>
          <JDFFeature>
            <Setting JDF=“LayoutElement_1”/>
          </JDFFeature>
        </rRef>
      </LayoutElementRef>
    </RunList>
    <Component>
      <ComponentType>
        <JDFFeature>
          <Setting JDF=“FinalProduct”/>
          <Setting JDF=“PartialProduct”/>
        </JDFFeature>
      </ComponentType>
    </Component>
  </ResourcePool>
  <ResourceLinkPool>
    <ComponentLink>
      <Amount>
        <JDFFeature>
          <Setting JDF=“INTEGER” PS=“[1000 {SetNumCopies}]”/>
        </JDFFeature>
      </Amount>
      <Orientation>
        <PPDFeature Name=“StapleLocation” OEM=“OEM1”>
          <Setting PPD=“UpperLeft LeftW” JDF=“Rotate0”/>
          <Setting PPD=“UpperW UpperRight CenterW” JDF=“Rotate90”/>
          <Setting PPD=“RightW LowerRight” JDF=“Rotate180”/>
          <Setting PPD=“LowerW LowerLeft” JDF=“Rotate270”/>
        </PPDFeature>
        <PPDFeature Name=“EFStapler” OEM=“OEM2”>
          <Setting PPD=“1UpLeftH 1UpLeftS 1UpLeftV 2Left” JDF=“Rotate0”/>
          <Setting PPD=“2Up 1UpRightH 1UpRightS 1UpRightV Center” JDF=“Rotate90”/>
          <Setting PPD=“2Right” JDF=“Rotate180”/>
        </PPDFeature>
        <PPDFeature Name=“StapleLocation” OEM=“OEM3”>
          <Setting PPD=“LeftDiagonal LeftHorizontal LeftVertical DoubleLeft”
JDF=“Rotate0”/>
          <Setting PPD=“DoubleTop” JDF=“Rotate90”/>
          <Setting PPD=“RightDiagonal RightHorizontal RightVertical DoubleRight”
            JDF=“Rotate180”/>
        </PPDFeature>
        <PPDFeature Name=“RIPunch” OEM=“OEM1”>
          <Setting PPD=“Left2 Left3 Left4 GBCLeft” JDF=“Rotate0”/>
          <Setting PPD=“Upper2 Upper3 Upper4 GBCTop” JDF=“Rotate90”/>
          <Setting PPD=“Right2 Right3 Right4 GBCRight” JDF=“Rotate180”/>
          <Setting PPD=“Lower2 Lower3 Lower4 GBCBottom” JDF=“Rotate270”/>
        </PPDFeature>
        <PPDFeature Name=“EFPunchEdge” OEM=“OEM2”>
          <Setting PPD=“Left” JDF=“Rotate0”/>
          <Setting PPD=“Top” JDF=“Rotate90”/>
          <Setting PPD=“Right” JDF=“Rotate180”/>
        </PPDFeature>
        <PPDFeature Name=“Punch” OEM=“OEM3”>
          <Setting PPD=“PunchLeft” JDF=“Rotate0”/>
          <Setting PPD=“PunchRight” JDF=“Rotate90”/>
          <Setting PPD=“PunchTop” JDF=“Rotate180”/>
          <Setting PPD=“PunchBottom” JDF=“Rotate270”/>
        </PPDFeature>
      </Orientation>
    </ComponentLink>
  </ResourceLinkPool>
</JDF>
```

We claim:

1. A method for printing a print job on a printing system, the method comprising:
providing a printer description file for the printing system, the printer description file including a plurality of entries each entry associating a device feature name and a device feature setting name and a corresponding device command string;
providing a mapping file having a plurality of entries wherein each entry maps one or more Job Definition Format (JDF) feature names to one or more device feature names and to one or more device feature setting names;
generating, in a computing system, a device capability file based on the printer description file and on the mapping file, the device capability file associating each of a plurality of Job Definition Format (JDF) feature names with a corresponding one or more device feature setting names;
generating a device PostScript table based on the printer description file and the mapping file, the device PostScript table associating one or more JDF feature names with one or more device feature setting names and with one or more device command strings corresponding to the one or more device feature setting names;
generating, in the computing system, a JDF job ticket for a print job based on the device capability file;
transmitting the JDF job ticket and print job data associated with the print job from the computing system to the printing system;
translating, within the printing system, entries of the JDF job ticket into corresponding device command strings based on entries in the device PostScript table; and
executing, within the printing system, the corresponding device command strings and the print job data to generate printed output for the print job.

2. The method of claim 1
wherein the step of generating the device capability file further comprises:
generating the device capability file wherein the device capability file includes constraint information for validating the generated JDF job ticket in the computing system,
wherein the step of generating the JDF job ticket further comprises:
validating the generated JDF job ticket based on the constraint information to confirm that the print job identified by the generated JDF job ticket may be executed on some possible configuration of the printing system.

3. The method of claim 1
wherein the step of generating the device capability file further comprises:
generating the device capability file wherein the device capability file includes constraint information for validating the generated JDF job ticket in the computing system, wherein the constraint information includes device queries to determine the current configuration of the printing system,
wherein the step of generating the JDF job ticket further comprises:
determining the current configuration of the printing system based on responses to execution of the device queries; and
validating the generated JDF job ticket based on the constraint information and the current configuration to confirm that the print job identified by the generated JDF job ticket may be executed on the current configuration of the printing system.

4. The method of claim 1
wherein the step of generating the device capability file further comprises:
generating the device capability file wherein the device capability file includes constraint information for validating the generated JDF job ticket in the computing system, wherein the constraint information includes device queries to determine the current configuration of the printing system,
wherein the step of transmitting the JDF job ticket further comprises:
determining the current configuration of the printing system based on responses to execution of the device queries; and
validating the generated JDF job ticket based on the constraint information and the current configuration to confirm that the print job identified by the generated JDF job ticket may be executed on the current configuration of the printing system.

5. The method of claim 1
wherein the step of generating the device PostScript table further comprises:
generating the device PostScript table wherein the device PostScript table includes constraint information for validating a JDF job ticket received from the computing system, and
the method further comprising:
validating, within the printing system, the JDF job ticket based on the constraint information to confirm that the print job identified by the received JDF job ticket may be executed on the printing system.

6. The method of claim 1
wherein the printing system is a PostScript printing system, and
wherein the step of providing a printer description file further comprises:
providing a PostScript Printer Description (PPD) file for the PostScript printing system.

7. The method of claim 6 further comprising:
wherein the device PostScript table comprises a PostScript dictionary data structure in the PostScript printing system.

8. The method of claim 6 further comprising:
wherein the device PostScript table comprises a PostScript array data structure in the PostScript printing system.

9. A method operable in a PostScript printing system controller for processing a Job Definition Format (JDF) job ticket associated with a print job, the method comprising:
providing a device PostScript table stored within the PostScript printing system controller, the device PostScript table having a plurality of entries, each entry mapping one or more JDF feature names and JDF setting names to a device command string to be executed by the printing system controller to invoke a desired JDF feature;
receiving a JDF job ticket and associated print job data wherein the JDF job ticket comprises one or more JDF elements each specifying a desired JDF feature name and a desired JDF feature setting name;
locating an entry in the device PostScript table based on one or more desired JDF feature names and one or more desired JDF feature setting names;
processing a value field of the located entry to generate one or more device command strings; and
processing the one or more generated device command strings and the print job data to generate printed output.

10. The method of claim 9 further comprising:
providing constraint information in the device PostScript table stored within the PostScript printing system controller, the constraint information identifying mutually exclusive groups of JDF feature names and JDF feature setting names.

11. The method of claim 10 further comprising:
validating, within the PostScript printing system controller, the received JDF job ticket based on the constraint information.

12. The method of claim 10
wherein the constraint information further comprises device query commands to determine the current configuration of the PostScript printing system, and
wherein the method further comprises:
validating that the JDF job ticket may be executed by the PostScript printing system in its current configuration.

13. The method of claim 9
wherein the device PostScript table includes ordering information that defines the order of processing of the generated device command strings, and
wherein the step of processing further comprises:
processing the one or more generated device command strings and the print job data to generate printed output wherein the processing is in an order defined by the ordering information in the device PostScript table.

14. A system comprising:
a computing system, the computing system further comprising:
a mapping file having a plurality of entries wherein each entry maps one or more Job Definition Format (JDF) feature names to one or more device feature names and to one or more device feature setting names;
a printer description file comprising information regarding available device feature names and device feature setting names of a corresponding printing system;
a printing system initialization component coupled to receive the printer description file,
wherein the printing system initialization component is adapted to generate a device capability files based on the printer description file and based on the mapping file, the device capability file comprising entries associating one or more available device feature setting names with one or more corresponding JDF feature names, and
wherein the printing system initialization component is further adapted to generate a device PostScript table based on the printer description file and based on the mapping file, the device PostScript table comprising entries associating one or more device feature setting names and one or more corresponding JDF feature names with one or more device command strings which, when executed by a printing system, invokes the device feature setting name, wherein the initialization component is further adapted to transmit the device PostScript table to the printing system; and
a job generator component coupled to receive the device capability file,
wherein the job generator component is adapted to generate a JDF job ticket based on user input and based on the information in the device capability file, and
wherein the job generator component is further adapted to transmit the generated JDF job ticket and associated print job data to the corresponding printing system to generate printed output in accordance with the device PostScript table.

15. The system of claim 14 further comprising:
a printing system coupled with the computing system to receive the device PostScript table and the JDF job ticket and the associated print job data, the printing system further comprising:
a JDF job ticket processing component adapted to process the JDF job ticket by translating the elements of the JDF job ticket into device command strings based on the device PostScript table; and
a print job processing component adapted to generate the printed output based on the device command strings and based on the associated print job data.

16. The system of claim 15
wherein the printing system initialization component is further adapted to generate constraint information based on the printer description file and based on the mapping file,
wherein the printing system initialization component is further adapted to transmit the constraint information to the corresponding printing system,
wherein the JDF job ticket processing component is further adapted to validate the JDF job ticket based on the constraint information, and
wherein the JDF job ticket processing component is further adapted to signal an error responsive to determining that the JDF job ticket is invalid.

17. The system of claim 16 wherein the constraint information is integral with the device PostScript table.

18. The system of claim 14
wherein the printing system initialization component is further adapted to generate constraint information within the device capability file based on the printer description file and based on the mapping file,
wherein the job generator component is further adapted to validate the JDF job ticket based on the constraint information.

19. The system of claim 18
wherein the constraint information includes device queries to determine the current configuration of the printing system,
wherein the job generator is further adapted to determine the current configuration of the printing system based on responses to execution of the device queries, and
wherein the job generator component is further adapted to validate the JDF job ticket based on the constraint information and the current configuration while generating the JDF job ticket.

20. The system of claim 18
wherein the constraint information includes device queries to determine the current configuration of the printing system,
wherein the job generator is further adapted to determine the current configuration of the printing system based on responses to execution of the device queries, and
wherein the job generator component is further adapted to validate the JDF job ticket based on the constraint information and the current configuration prior to transmitting the JDF job ticket.
